(19) United States
(12) Patent Application Publication
(10) Pub. No.: US 2011/0174704 A1
(43) Pub. Date: Jul. 21, 2011

(54) FUEL FILTER DEVICE

(75) Inventors: Katsuhisa YAMADA, Okazaki-city (JP); Chiaki KAWAJIRI, Anjo-city (JP); Masaaki TANAKA, Tsu-city (JP); Noriya MATSUMOTO, Okazaki-city (JP)

(73) Assignee: DENSO CORPORATION, Kariya-city (JP)

(21) Appl. No.: 13/009,113

(22) Filed: Jan. 19, 2011

(30) Foreign Application Priority Data
Jan. 19, 2010 (JP) 2010-9371
Aug. 31, 2010 (JP) 2010-193270

(51) Int. Cl. B01D 35/02; F02M 37/22; B01D 35/157

(52) U.S. Cl. 210/137; 210/489; 210/486

(57) ABSTRACT

A suction filter has a filter member including multiple filter layers stacked in a thickness direction. The suction filter removes extraneous matters contained in fuel when the fuel passes through the filter member in the thickness direction. The filter member has gaps among the filter layers adjacent to each other in the thickness direction. An opening area variable section is formed in at least one of the filter layers. The opening area variable section enlarges and opens when the filter layer bends. The opening area variable section enlarges and opens to form a through hole penetrating through the filter layer if the filter layer bends to a downstream filter layer side due to flow pressure caused when the fuel flows.

### CROSS REFERENCE TO RELATED APPLICATION

This application is based on and incorporates herein by reference Japanese Patent Applications No. 2010-9371 filed on Jan. 19, 2010 and No. 2010-193270 filed on Aug. 31, 2010.

### BACKGROUND OF THE INVENTION

1. Field of the Invention

The present invention relates to a fuel filter device that removes extraneous matters contained in fuel of an internal combustion engine.

2. Description of Related Art

Conventionally, there has been a known device described in Patent document 1 (JP-A-2005-48721) as a fuel filter device for removing extraneous matters contained in fuel of an internal combustion engine, for example. This conventional fuel filter device has a filter section consisting of two or more nonwoven fabric layers having different void ratios. The void ratio is a ratio of void parts to a total volume. The void ratios of the filter section are set for the respective layers. The filter section is formed by forming the two or more nonwoven fabric layers by a meltblown method. The void ratios of the respective layers are decided to provide a gentle gradient of filtration ability in a thickness direction of the filter section (i.e., gentle density gradient in thickness direction of filter section). The extraneous matters having relatively large particle diameters in the fuel are trapped by the outside nonwoven fabric layer. The extraneous matters having relatively small particle diameters in the fuel are trapped by the inside nonwoven fabric layer. Thus, it is aimed to suppress clogging of the filter section as much as possible.

In the case where the density gradient of the filter section in the thickness direction is set as in the above-described conventional fuel filter device and the extraneous matters having a particle diameter distribution ranging to a certain degree are trapped, it is required to substantially equalize clogged states of the respective layers in order to extend a useful life of the filter section.

More specifically, when a large amount of the extraneous matters having the small particle diameters are contained in the fuel, clogging occurs in a fine layer although clogging has not occurred in a coarse layer. In such the case, the fine layer cannot exert its function and eventually the lifetime of the entire filter section shortens. As a countermeasure, filtration areas of the respective layers may be increased. However, the increase of the filtration areas causes increase of a size of the filter section, adversely affecting mountability of the device.

### SUMMARY OF THE INVENTION

It is an object of the present invention to provide a fuel filter device capable of suppressing a body size of the device and improving a lifetime of a filter.

According to a first example aspect of the present invention, a fuel filter device has a filter member including a plurality of filter layers stacked in a thickness direction. The fuel filter device removes extraneous matters contained in fuel when the fuel passes through the filter member in the thickness direction. At least one of the filter layers has a fuel passing quantity variable section that is set with a pressure loss larger than a pressure loss in the other part of the filter layer than the fuel passing quantity variable section. The pressure loss in the fuel passing quantity variable section is set at a specific pressure loss such that a magnitude relationship between the pressure loss in the fuel passing quantity variable section and the pressure loss in the other part reverses in a process of accumulation of a passing quantity of the fuel passing through the filter member and progression of the removal of the extraneous matters.

In the fuel filter device, as the fuel passes through the filter member in the thickness direction, the extraneous matters contained in the fuel are trapped by the respective filter layers. The fuel component, from which the extraneous matters have been removed, passes through the filter member and flows downstream. If the quantity of the extraneous matters removed by the filter layers increases further, the voids formed in the filter layers are filled up with the extraneous matters, so the filter layers approach a clogged state.

Therefore, according to the above-described aspect of the present invention, the filter layer has the fuel passing quantity variable section set with the pressure loss larger than the pressure loss in the other part of the filter layer. With such the construction, when the fuel passes through the filter member, the fuel cannot pass easily through the fuel passing quantity variable section set with the large pressure loss. The fuel can pass easily through the other part of the filter layer than the fuel passing quantity variable section. Therefore, the extraneous matters are removed in the other part. The pressure loss in the fuel passing quantity variable section is set at the specific pressure loss such that the magnitude relationship between the pressure loss in the fuel passing quantity variable section and the pressure loss in the other part reverses in the process of the accumulation of the passing quantity of the fuel and the progression of the removal of the extraneous matters. Accordingly, the pressure loss in the other part exceeds the pressure loss in the fuel passing quantity variable section as the clogging in the other part of the filter layer progresses. If such the state is reached, it becomes difficult for the fuel to pass through the other part, in which the pressure loss has increased. At this time, the fuel passes through the fuel passing quantity variable section and flows to the downstream filter layer side. The downstream filter layer begins to exert the function to remove the extraneous matters contained in the fuel.

In this way, if the clogging in the other part of the filter layer, which has the fuel passing quantity variable section, than the fuel passing quantity variable section progresses, the fuel passes through the fuel passing quantity variable section and the downstream filter layer begins to exert the extraneous matter trapping ability at the timing when the magnitude relationship between the pressure loss in the other part and the pressure loss in the fuel passing quantity variable section reverses. Thus, the filtration fully utilizing the extraneous matter trapping abilities of the respective filter layers can be performed. Accordingly, the filtration area of the filter member can be reduced. Thus, the fuel filter device capable of suppressing the body size of the device and improving the filter lifetime can be provided.

According to a second example aspect of the present invention, the filter member has at least one gap between the filter layers adjacent to each other in the thickness direction. The fuel passing quantity variable section is a through hole having a predetermined opening area satisfying the specific pressure loss.

According to the above-described aspect of the present invention, an opening area satisfying the condition that the pressure loss in the fuel passing quantity variable section is larger than the pressure loss in the other part when the clogging has not occurred in the filter layer and the condition that the magnitude relationship of the pressure losses reverses at a predetermined progression degree of the clogging may be obtained and the through hole having the size satisfying the opening area may be formed. Therefore, the fuel passing quantity variable section to be formed can be decided relatively easily. The fuel passing quantity variable section can be formed easily.

According to a third example aspect of the present invention, the filter member has at least one middle layer, which has a larger void ratio than the filter layers, between the filter layers adjacent to each other in the thickness direction. The fuel passing quantity variable section is a through hole having a predetermined opening area satisfying the specific pressure loss.

According to the above-described aspect of the present invention, effects similar to the effects of the second example aspect of the present invention can be exerted. The middle layer has the larger void ratio than the filter layer. Therefore, the fuel having passed through the through hole can be distributed widely to the downstream filter layer. The middle layer has a function to maintain an interval between the filter layers at a predetermined interval, thereby stabilizing the shape of the filter member.

According to a fourth example aspect of the present invention, the specific pressure loss satisfied by the through hole resides in a range from 1.5 kPa to 4 kPa. According to this aspect of the present invention, when the present invention is applied to the filter device filtering the fuel such as the gasoline or the light oil, excellent effects to suppress the device body size and to improve the filter lifetime can be expected.

According to a fifth example aspect of the present invention, the through holes respectively provided in the filter layers adjacent to each other in the thickness direction are formed in positions deviated from each other in a direction perpendicular to the thickness direction such that the through holes do not overlap with each other in the thickness direction.

According to the above-described aspect of the present invention, the through holes respectively provided in the filter layers adjacent to each other in the thickness direction are distanced from each other in the direction perpendicular to the thickness direction such that the through holes do not overlap with each other in the thickness direction. Therefore, the fuel having passed through the through hole in the upstream filter layer is surely filtered by the downstream filter layer. After the downstream filter layer clogs, the fuel begins to pass through the through hole of the downstream filter layer. Therefore, the extraneous matter trapping ability can be fully exerted in the downstream filter layer. Thus, the filter member can secure the extraneous matter trapping ability, so the lifetime of the filter can be extended certainly.

According to a sixth example aspect of the present invention, the through hole is formed in the filter layer having the smallest void ratio among the filter layers except for the filter layer arranged on the most downstream side with respect to a fuel flow direction. According to this aspect of the present invention, the through hole is formed in the filter layer that is upstream of the most downstream filter layer and that clogs early among the multiple stacked filter layers. Therefore, even if the filter layer having the through hole dogs, the extraneous matters can be trapped by the downstream filter layer. Therefore, the lifetime of the entire filter member can be extended.

According to a seventh example aspect of the present invention, the filter member has at least one gap between the filter layers adjacent to each other in the thickness direction. The fuel passing quantity variable section is an opening area variable section that enlarges and opens when the filter layer bends. The opening area variable section forms a through hole penetrating through the filter layer by enlarging and opening when the filter layer, in which the opening area variable section is formed, bends toward the filter on the downstream side with respect to a fuel flow direction due to flow pressure caused when the fuel flows in the process of the accumulation of the passing quantity of the fuel passing through the filter member and the progression of the removal of the extraneous matters.

According to the above-described aspect of the present invention, if the clogging of the filter layer progresses to a certain degree, the differential pressure across the filter layer increases, so the filter layer deforms and bends toward the downstream gap side due to the flow pressure of the fuel. Due to the deformation, the opening area variable section beforehand provided in the filter layer enlarges and opens to form the through hole penetrating through the filter layer. Therefore, the fuel passes through the opening area variable section having enlarged and opened and is filtered by the downstream filter layer rather than passing through the void parts of the filter layer having already clogged. In this way, if the upstream filter layer approaches the upper limit of the extraneous matter trapping ability, the fuel passes through the opening area variable section, and the downstream filter layer begins to exert the extraneous matter trapping ability. Accordingly, the extraneous matter trapping abilities of the multiple filter layers can be fully utilized and the filtration area can be reduced. Thus, the fuel filter device capable of suppressing the body size of the device and improving the filter lifetime can be provided.

According to an eighth example aspect of the present invention, the filter member has at least one middle layer, which has a larger void ratio than the filter layers, between the filter layers adjacent to each other in the thickness direction. The fuel passing quantity variable section is an opening area variable section that enlarges and opens when the filter layer bends. The opening area variable section forms a through hole penetrating through the filter layer by enlarging and opening when the filter layer, in which the opening area variable section is formed, bends toward the filter on the downstream side with respect to a fuel flow direction due to flow pressure caused when the fuel flows in the process of the accumulation of the passing quantity of the fuel passing through the filter member and the progression of the removal of the extraneous matters.

According to the above-described aspect of the present invention, if the clogging of the filter layer progresses to a certain degree, the differential pressure across the filter layer increases, so the filter layer deforms to bend toward the downstream middle layer side due to the flow pressure of the fuel like the seventh example aspect of the present invention. Since the middle layer has the larger void ratio than the filter layer, the middle layer is soft. Therefore, the middle layer helps the filter layer bend toward the middle layer side. The middle layer has a function to maintain the interval between the filter layers at a predetermined interval, thereby stabilizing the shape of the filter member. Due to the deformation, the fuel passes through the opening area variable section having enlarged and opened and is filtered by the downstream filter layer rather than passing through the void parts of the filter layer having already clogged. In this way, if the upstream filter layer approaches the upper limit of the extraneous matter trapping ability, the fuel passes through the opening area variable section, and the downstream filter layer begins to exert the extraneous matter trapping ability. Accordingly, the extraneous matter trapping abilities of the multiple filter layers can be fully utilized, so the filtration area can be reduced. Thus, the fuel filter device capable of suppressing the body size of the device and improving the filter lifetime can be provided.

According to a ninth example aspect of the present invention, the opening area variable sections respectively provided in the filter layers adjacent to each other in the thickness direction are formed in positions deviated from each other in a direction perpendicular to the thickness direction such that the through holes do not overlap with each other in the thickness direction.

According to the above-described aspect of the present invention, the opening area variable sections respectively provided in the filter layers adjacent to each other in the thickness direction are distanced from each other in the direction perpendicular to the thickness direction such that the through holes do not overlap with each other in the thickness direction. Therefore, the fuel having passed through the opening area variable section having enlarged and opened is surely filtered by the downstream filter layer. After the downstream filter layer clogs, the fuel begins to pass through the opening area variable section having enlarged and opened in the downstream filter layer. Therefore, the extraneous matter trapping ability can be fully exerted in the downstream filter layer. Accordingly, the filter member can secure the extraneous matter trapping ability, and the lifetime of the filter can be extended certainly.

According to a tenth example aspect of the present invention, the opening area variable section is formed in the filter layer having the smallest void ratio among the filter layers except for the filter layer arranged on the most downstream side with respect to a fuel flow direction.

According to the above-described aspect of the present invention, the opening area variable section is formed in the filter layer that is upstream of the most downstream filter layer and that clogs early among the multiple stacked filter layers. Therefore, even if the filter layer having the opening area variable section clogs, the extraneous matters can be trapped by the downstream filter layer. Therefore, the lifetime of the entire filter member can be extended.

According to an eleventh example aspect of the present invention, the opening area variable section is a cut section or a slit penetrating through the filter layer. According to this aspect of the present invention, the opening area variable section capable of exerting the above-mentioned function can be formed by press processing and the like. Therefore, the fuel filter device having excellent processability and productivity can be provided.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a schematic view showing a suction filter according to a first embodiment of the present invention;

FIG. 2 is a schematic cross-sectional view showing a filter member of a fuel filter device according to the first embodiment;

FIG. 3 is a partial plan view showing the filter member according to the first embodiment;

FIG. 4 is a graph showing a relationship between a temporal change of a pressure loss in a filter layer and a set value of a pressure loss in a through hole according to the first embodiment;

FIG. 5 is a graph showing a relationship between an opening area and a pressure loss of a through hole formed in a filter layer;

FIG. 6 is a graph showing an experimental result of temporal changes of pressure losses in respective filter layers in a case where a single through hole having a hole diameter of 3 mm is formed in each filter layer;

FIG. 7 is a graph showing an experimental result of temporal changes of pressure losses in respective filter layers in a case where a single through hole having a hole diameter of 4 mm is formed in each filter layer;

FIG. 8 is a graph showing an experimental result of temporal changes of pressure losses in respective filter layers in a case where a single through hole having a hole diameter of 5 mm is formed in each filter layer;

FIG. 9 is a graph showing an experimental result of temporal changes of pressure losses in respective filter layers in a case where a through hole having a hole diameter of 3 mm and a through hole having a hole diameter of 4 mm are formed in each filter layer;

FIG. 10 is a graph showing an experimental result of temporal changes of pressure losses in respective filter layers in a case where three through holes each having a hole diameter of 3 mm are formed in each filter layer;

FIG. 11 is a graph showing an experimental result of temporal changes of pressure losses in respective filter layers in a case where two through holes each having a hole diameter of 2 mm and another two through holes each having a hole diameter of 3 mm are formed in each filter layer;

FIG. 12 is a schematic cross-sectional view showing a filter member of a fuel filter device according to a second embodiment of the present invention;

FIG. 13 is a partial plan view showing the filter member according to the second embodiment;

FIG. 14 is a cross-sectional view showing a state where a first filter layer of the filter member bends to form a through hole according to the second embodiment;

FIG. 15 is a cross-sectional view showing a state where a second filter layer of the filter member bends to form a through hole according to the second embodiment;

FIG. 16 is a cross-sectional view showing a state where a third filter layer of the filter member bends to form a through hole according to the second embodiment;

FIG. 17 is a graph showing an experimental result of temporal changes of pressure losses in respective filter layers of a conventional filter member having no cut section in the layers as a comparative example;

FIG. 18 is a graph showing an experimental result of temporal changes of pressure losses in respective filter layers of a filter member having no gap between the adjacent filter layers;

FIG. 19 is a graph showing an experimental result of temporal changes of pressure losses in respective filter layers of the filter member according to the second embodiment;

FIG. 20 is a partial plan view showing a filter member according to a first modification of the second embodiment;

FIG. 21 is a partial plan view showing a filter member according to a second modification of the second embodiment;

FIG. 22 is a partial plan view showing a filter member according to a third modification of the second embodiment;

FIG. 23 is a schematic cross-sectional view showing a filter member of a fuel filter device according to a third embodiment of the present invention;

FIG. 24 is a schematic cross-sectional view showing a filter member of a fuel filter device according to a fourth embodiment of the present invention;

FIG. 25 is a schematic cross-sectional view showing a fuel filter device according to a fifth embodiment of the present invention;

FIG. 26 is a schematic cross-sectional view showing a fuel filter device according to a sixth embodiment of the present invention;

FIG. 27 is a schematic cross-sectional view showing a filter member according to a seventh embodiment of the present invention; and

FIG. 28 is a schematic cross-sectional view showing a fuel filter device according to the seventh embodiment.

### DETAILED DESCRIPTION OF EXAMPLE EMBODIMENTS

Hereafter, embodiments of the present invention will be explained with reference to the drawings. The same reference numeral is used for the same or equivalent part among the embodiments.

### First Embodiment

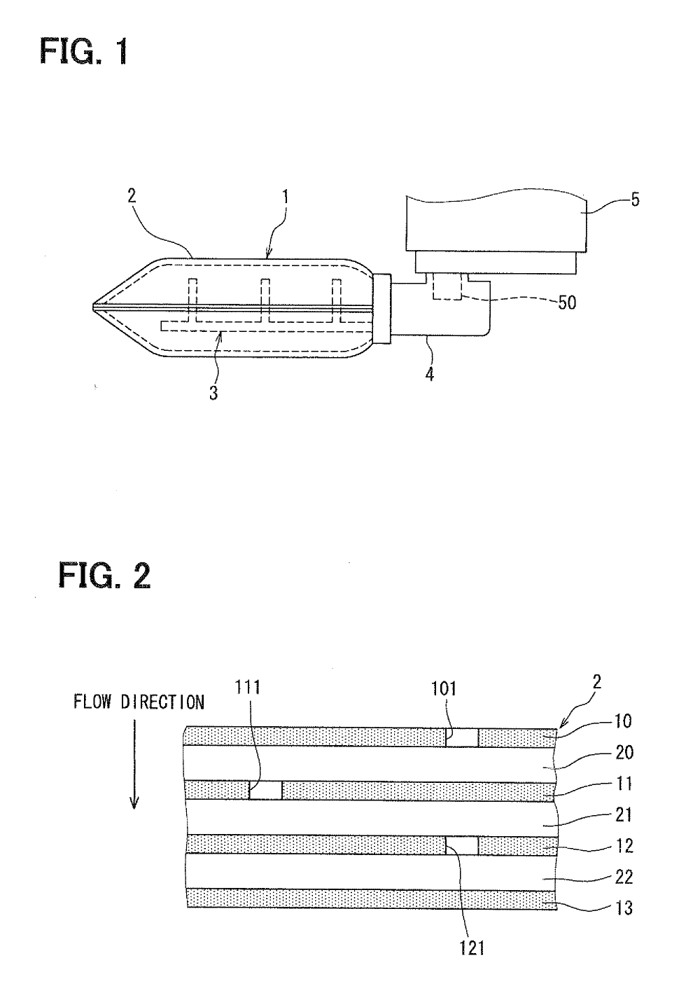

A first embodiment of the present invention will be explained with reference to FIGS. 1 to 11 below. In the first embodiment, a fuel filter device according to the present invention is applied to a suction filter 1. FIG. 1 is a schematic diagram showing a device, in which the suction filter 1 is applied to a fuel pump 5.

The fuel pump 5 is accommodated in a fuel tank (not shown) of a vehicle or the like in a fuel supply system of an electronic fuel injection system, for example. The fuel pump 5 supplies fuel suctioned from the fuel tank to an engine side. The used fuel is gasoline, light oil, alcohol-blended fuel, bioethanol, hundred-percent ethanol fuel or the like.

A flange section (not shown) formed in an upper part of a housing of the fuel pump 5 is fixed to the fuel tank. A discharge pipe, an external connector and an internal connector (not shown) are provided to the flange section. The discharge pipe is a pipe connected in order to discharge the fuel to the engine side. The external connector and the internal connector supply power to a pump main body (not shown) and output a signal of a liquid level sensed with a liquid level meter (not shown) to an external controller.

The housing of the fuel pump 5 has a filter case accommodating a filter element (not shown) and a pump case accommodating the pump main body. The housing incorporates the pump main body and a pressure regulator (not shown) inside. The pressure regulator is connected to a fuel passage (not shown), via which the fuel is supplied from the filter element to the discharge pipe. The pressure regulator regulates the pressure of the fuel discharged from the discharge pipe to an outside of the fuel tank.

The suction filter 1 is connected to a fuel inlet 50 on a fuel suction side of the fuel pump 5. The suction filter 1 is a filter member for removing extraneous matters contained in the fuel when the fuel suctioned through the fuel inlet 50 by the pump main body passes through the suction filter 1. The extraneous matters are dusts, unnecessary matters and the like that are contained in the fuel and that do not contribute to generation of energy. The fuel stored in the fuel tank is suctioned to an inside of the fuel pump 5 through the fuel inlet 50 after relatively large extraneous matters are removed by the suction filter 1. The fuel suctioned to the inside of the fuel pump 5 is pressurized by the pump main body and flows into the filter element. Smaller extraneous matters contained in the fuel are removed by the filter element. The fuel having passed through the filter element is discharged to the outside of the fuel pump 5 through the discharge pipe after the pressure of the fuel is regulated by the pressure regulator.

The suction filter 1 has a sac-like filter member 2 consisting of multiple layers made of nonwoven fabric, a skeleton member 3 supporting the filter member 2, and a mounting member 4 functioning as an attachment. The skeleton member 3 and the mounting member 4 are made of oilproof resin. By fixing the mounting member 4 to the skeleton member 3, the filter member 2 is tucked and held between the skeleton member 3 and the mounting member 4. The skeleton member 3 and the mounting member 4 are connected by snap fitting, for example. The mounting member 4 is fixed to the fuel inlet 50 of the fuel pump 5.

Before the filter member 2 is formed in the sac-like shape, the filter member 2 is a sheet-like member having an opening (not shown) of a predetermined size in its center. After the skeleton member 3 and the mounting member 4 are fixed to the opening of the filter member 2, the filter member 2 is folded such that longitudinal ends of the sheet-like member overlap with each other. Outer peripheral edges of the folded filter member 2 are heated such that the edges melt and adhere to each other. Thus, the filter member 2 is formed in the sac-like shape accommodating the skeleton member 3 inside as shown in FIG. 1.

Because of such the sac-like structure of the filter member 2, the fuel inflows from the outside of the sac-like filter member 2 to the inside of the sac-like filter member 2 surrounded in the sac-like shape. Since the filter member 2 has the sac-like shape, a necessary installation space can be reduced as compared to the case where the filter member has the same filtration area and is formed in a shape other than the sac-like shape. Therefore, the filtration area of the filter member 2 can be secured without increasing the installation space of the suction filter 1. The skeleton member 3 supports the filter member 2 from the inside. Therefore, even when the suction filter 1 is located in the fuel stored in the fuel tank, the filter member 2 can maintain the sac-like shape and can maintain the filtration area.

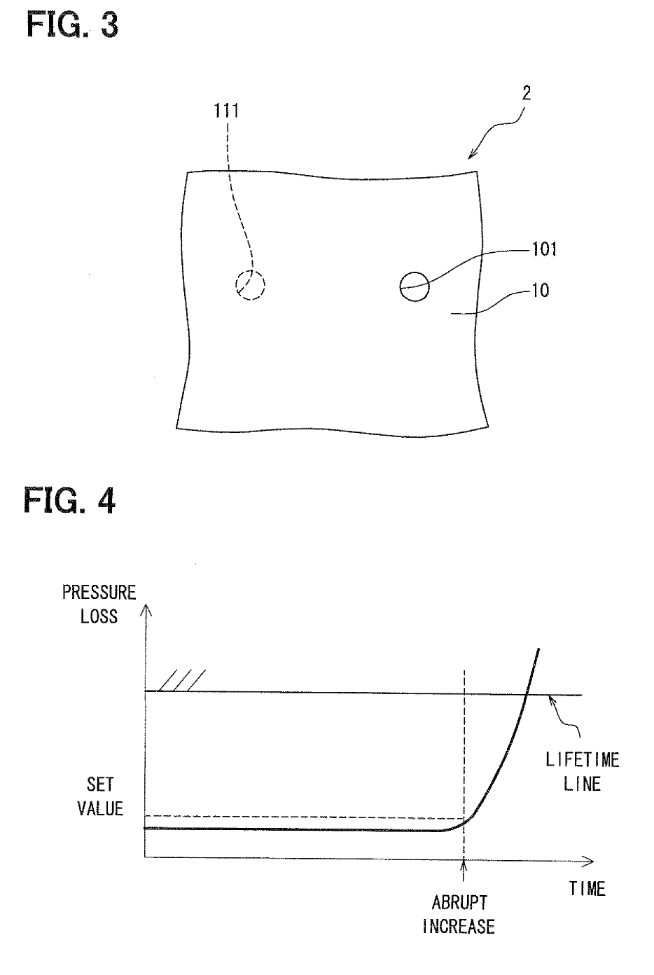

FIG. 2 is a schematic cross-sectional view showing the construction of the filter member 2. FIG. 3 is a partial plan view of the filter member 2 of FIG. 2. As shown in FIG. 2, the filter member 2 is constituted by four nonwoven fabric layers consisting of a first filter layer 10, a second filter layer 11, a third filter layer 12 and a fourth filter layer 13 stacked in this order from the outside to the inside of the filter member 2 in a thickness direction of the filter member 2. The thickness direction of the filter member 2 coincides with a fuel flow direction. The respective filter layers according to the present embodiment have fine void parts respectively. Void ratios of the respective filter layers are set substantially equal to each other. The void ratio is a ratio of the void parts to a total volume of the filter layer. However, using the nonwoven fabric layers having the specified void ratios as the respective filter layers is not a prerequisite for exerting the effects of the fuel filter device according to the present invention. That is, the multiple filter layers 10-13 may have the same void ratio. Alternatively, a density gradient in the thickness direction of the filter member 2 may be set by providing differences among the void ratios of the respective filter layers.

The void ratios of the respective filter layers 10-13 can be set by setting wire diameters of the fibers constituting the respective nonwoven fabric layers at predetermined values. For example, when the dense layer is to be formed by reducing the void ratio, the dense layer can be formed by using the fiber having the small wire diameter. When the coarse layer is to be formed by increasing the void ratio, the coarse layer can be formed by using the fiber having the large wire diameter. In the present embodiment, the fibers constituting the respective filter layers 10-13 are made of PET resin (polyethylene terephthalate resin) or polyamide type resin having high oil resistance. The nonwoven fabric can be manufactured by a dry method, a spunbond method, a meltblown method, a wet method or the like, for example.

As shown in FIGS. 2 and 3, a first through hole 101 is beforehand formed in the outermost first filter layer 10. The first through hole 101 has a predetermined opening area and penetrates through the first filter layer 10 in the thickness direction. A second through hole 111 is beforehand formed in the second filter layer 11, which is arranged inside the first filter layer 10 across a gap 20. The second through hole 111 is formed in a position, which is distanced from a position of the first through hole 101 of the first filter layer 10 in a direction perpendicular to the fuel flow direction (downward direction in FIG. 2). The second through hole 111 has a predetermined opening area like the first through hole 101 and penetrates through the second filter layer 11 in the thickness direction. A third through hole 121 is beforehand formed in the third filter layer 12, which is arranged inside the second filter layer 11 across a gap 21. The third through hole 121 is formed in a position, which is distanced from the position of the second through hole 111 of the second filter layer 11 in the direction perpendicular to the fuel flow direction. The third through hole 121 also has a predetermined opening area and penetrates through the third filter layer 12 in the thickness direction. No cut section is formed in the innermost fourth filter layer 13. Although the cross-sectional shape of each of the through holes 101,111,121 is a circular shape in the drawings, the present invention is not limited thereto. Alternatively, each of the through holes 101, 111, 121 may have the shape of a slit having very narrow width, an oval, a square or the like.

The respective filter layers 10-13 are arranged such that the gaps are formed among the filter layers adjacent to each other. More specifically, the gap 20 is formed between the first filter layer 10 and the second filter layer 11. The gap 21 is formed between the second filter layer 11 and the third filter layer 12. The gap 22 is formed between the third filter layer 12 and the fourth filter layer 13. The outermost first filter layer 10 serves as the most upstream layer, and the innermost fourth filter layer 13 serves as the most downstream layer. Therefore, the fuel passing through the filter member 2 flows to pass through the outermost first filter layer 10, the gap 20, the second filter layer 11, the gap 21, the third filter layer 12, the gap 22 and the innermost fourth filter layer 13 in series as shown by an arrow mark (flow direction) in FIG. 2.

The sheet-like member before the filter member 2 is formed in the sac-like shape is formed by stacking the filter layers 10-13 such that the above-mentioned gaps 20-22 are formed among the layers and then applying a dot adhesion process to the stacked body in the thickness direction at predetermined intervals. With such the method, portions of the filter layers 10-13 where the dot adhesion process is applied closely contact each other with no gap therebetween. The gaps 20, 21, 22 are formed among the portions of the filter layers 10-13 where the dot adhesion process is not applied as shown in FIG. 2.

FIG. 4 is a graph showing a relationship between a temporal change of a pressure loss in the filter layer and a set value of a pressure loss in the through hole. A solid line in FIG. 4 shows the temporal change of the pressure loss in the filter layer in the case where the fuel is passed through the filter member 2. A nonwoven fabric layer used as the filter layer in this experiment is made of a PET resin and has weight per unit area of 100 g/m², thickness of 0.6 mm, a filtration area of 50 cm², and a void ratio ranging from 0% to 90%. The experiment was performed by causing the gasoline or JIS (Japanese Industrial Standards) No. 2 light oil, each of which contains a predetermined quantity of JIS No. 11 dust and a predetermined quantity of JIS No. 8 dust at a ratio of two to one as test dust (contaminant), to flow down to the above-mentioned filter layer at a flow rate of 120 L/h.

This experiment revealed that the pressure loss in the filter layer remains substantially constant even if the trapping of the test dust progresses after the start of the experiment and then increases abruptly when a clogged state of the filter layer reaches a certain level (as shown by “ABRUPT INCREASE” timing and later period in FIG. 4). Thereafter, the pressure loss continues to increase, and eventually, the pressure loss reaches a value exceeding a lifetime line, above which the filter cannot exert the filtration function.

It is understood from this experiment result that, for example, if the clogged state of the upstream filter layer such as the first filter layer reaches proximity of the lifetime line of FIG. 4, the first filter layer becomes unable to pass the fuel. Therefore, it becomes difficult for the fuel to flow to the downstream filter layer such as the second filter layer, so the filtration function of the second filter layer cannot be utilized. Therefore, although the second and following filter layers are not clogged at all but are still usable, replacement of the filter member is necessitated. In order to avoid such the situation, it is necessary to cause the fuel to flow to the second filter layer side before the pressure loss in the first filter layer increases abruptly and approaches the lifetime line.

Therefore, in the present embodiment, the first through hole 101 penetrating through the first filter layer 10 is provided as a fuel passing quantity variable section. The fuel passing quantity variable section is used for positively causing the fuel to bypass the first filter layer 10 and to flow to the second filter layer 11 instead of passing through the first filter layer 10. The opening area of the first through hole 101 is set to provide a pressure loss that causes the fuel to pass through the other part (filtering medium part) of the first filter layer 10 than the first through hole 101 first and then to come to pass through the first through hole 101 without passing through the other part before the clogging of the other part reaches the lifetime line (limit). In this way, the first through hole 101 is required to function as the fuel passing quantity variable section, which changes from the state where the passage of the fuel is difficult to the state where the passing quantity of the fuel increases in the process of the progression of the filtration of the fuel in the filter member 2.

Therefore, the first through hole 101 is beforehand formed to have the opening area providing a larger pressure loss than the other part (filtering medium part) in the first filter layer 10. In addition, it is necessary to set the preset pressure loss in the first through hole 101 such that the magnitude relationship between the pressure loss in the first through hole 101 and the pressure loss in the other part (filtering medium part) reverses in the process of the accumulation of the passing quantity of the fuel passing through the filter member 2 and the progression of the removal of the extraneous matters.

It is preferable that the value of the pressure loss beforehand set in the first through hole 101 in this way is a set value shown in FIG. 4. That is, the value of the pressure loss set in the first through hole 101 should be preferably set at a value of the pressure loss in the filter layer immediately preceding the abrupt increase of the pressure loss characteristic of the filter layer shown by a bold line in FIG. 4. The experimental result revealed that the set value ranges from 1.5 kPa to 4 kPa. By setting the value of the pressure loss in this way, the situation where the fuel flows to the downstream filter layers before the filtering medium part of the upstream filter layer excluding the through hole effectively exerts the filtration function can be prevented. At the same time, the situation where the upstream filter layer completely clogs before the fuel is filtered by the downstream filters and the filter lifetime shortens can be prevented.

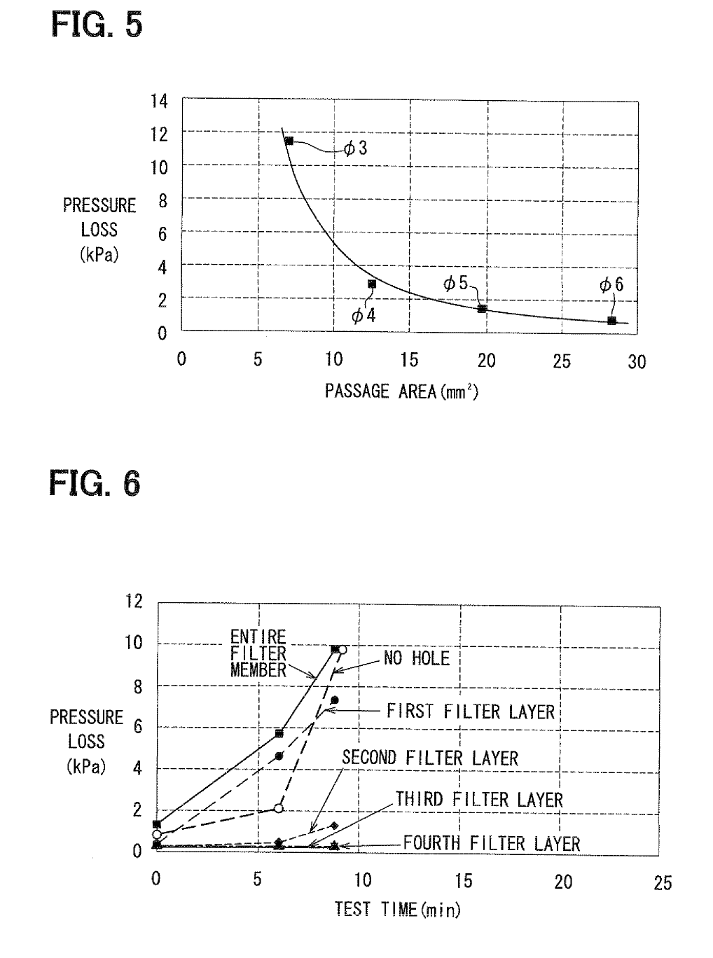

FIG. 5 is a graph showing a relationship between the opening area and the pressure loss of the through hole formed in the filter layer based on numerical computation. In FIG. 5, the pressure loss in the case where the gasoline or the JIS No. 2 light oil is caused to flow through each of the filter layer formed with the through hole having the hole diameter of 3 mm (φ3 in FIG. 5), the filter layer formed with the through hole having the hole diameter of 4 mm (φ4), the filter layer formed with the through hole having the hole diameter of 5 mm (φ5), and the filter layer formed with the through hole having the hole diameter of 6 mm (φ6) at the flow rate of 120 L/h is plotted. It is understood from this numerical computation result that the through hole should have the hole diameter of 4 mm or 5 mm in order to set the pressure loss in the through hole formed in the filter layer in the range from 1.5 kPa to 4 kPa.

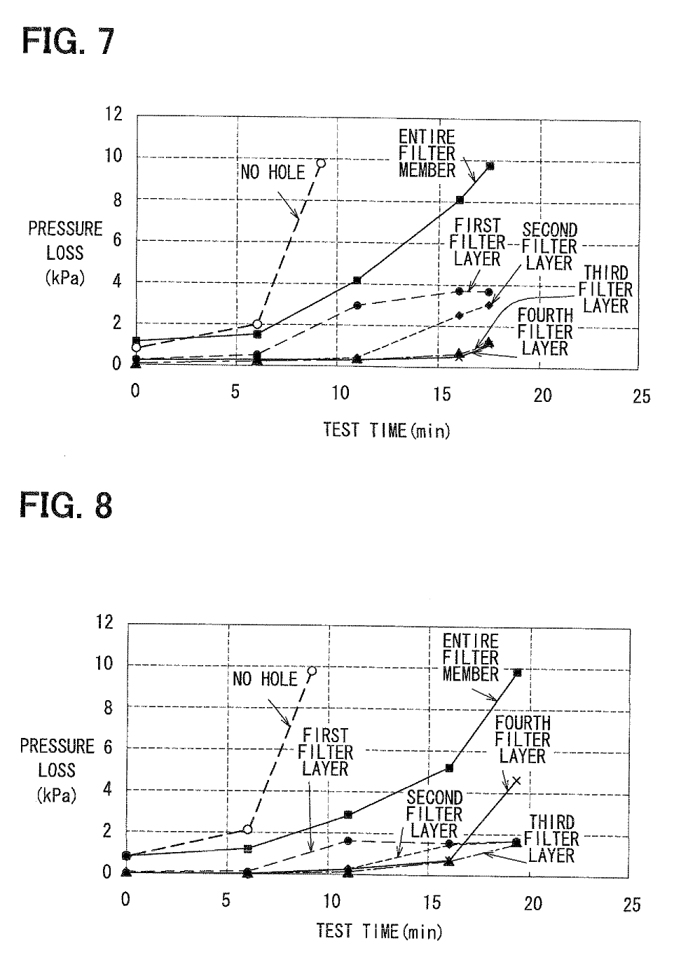

Next, experimental results of comparison about the temporal change in the pressure loss between the filter member 2 according to the present invention and the conventional filter member will be explained with reference to FIGS. 6 to 8. The opening area of the through hole of the filter member 2 according to the present invention used in the experiments is set at an area equivalent to an area of a through hole having a hole diameter of 3 mm (FIG. 6), an area of a through hole having a hole diameter of 4 mm (FIG. 7), and an area of a through hole having a hole diameter of 5 mm (FIG. 8), respectively.

Experimental conditions of the respective experimental results shown in FIGS. 6 to 8 are similar to the experimental condition of the experiment shown in FIG. 4. However, as the test dust (contaminant), 2.8 grams of JIS No. 11 dust and 1.4 grams of JIS No. 8 dust are put into the test fuel first at the start of the experiment. Then, the same quantity of JIS No. 11 dust as above and the same quantity of JIS No. 8 dust as above are put into the test fuel each time five minutes elapse. In this way, the quantity of the contaminant contained in the test fluid is increased. The four filter layers have the same thickness of 0.6 mm each and substantially the same void ratio. The pressure loss in the entire filter member 2 is calculated from differential pressure between the upstream side of the first filter layer 10 and the downstream side of the fourth filter layer 13. The pressure loss in each layer is calculated from differential pressure between an upstream side and a downstream side of the layer.

A broken line “NO HOLE” in each of FIGS. 6 to 8 shows the experimental result indicating the temporal change of the pressure loss in the entire filter of the conventional filter consisting of four filter layers formed with no through hole. In this conventional filter member, the extraneous matters are trapped by the outermost first filter layer first. If the first filter layer reaches a clogged state due to the extraneous matters, the pressure loss in the entire filter reaches a lifetime pressure loss. In this case, the downstream second to fourth filter layers hardly contribute to the trapping of the extraneous matters. Therefore, improvement of the filter lifetime cannot be expected.

The experimental result in FIG. 6 shows the result of the comparison between the filter member, in which each of the first filter layer 10, the second filter layer 11 and the third filter layer 12 has a single through hole having the hole diameter of 3 mm, and the conventional filter member. In the filter member, in which the single through hole having the hole diameter of 3 mm is formed in each filter layer, the pressure loss in the filtering medium part of the first filter layer 10 excluding the through hole is smaller than the pressure loss set in the single through hole having the hole diameter of 3 mm. Therefore, the pressure loss in the filtering medium part increases first in the first filter layer. The pressure loss in the filtering medium part keeps increasing but does not exceed the pressure loss set in the single through hole having the hole diameter of 3 mm. The fuel keeps passing through the filtering medium part without passing through the through hole. In this way, the clogging phenomenon occurs only in the first filter layer. It is because the value of the pressure loss set by the through hole having the hole diameter of 3 mm is large as shown in FIG. 5 and therefore the magnitude relationship between the pressure loss in the through hole and the pressure loss in the other part (filtering medium part) in the first filter layer does not reverse in the process of the progression of the removal of the extraneous matters in the fuel by the filter member.

If the clogging of the first filter layer reaches the limit, it becomes difficult for the first filter layer to trap the extraneous matters in the fuel further. Accordingly, the pressure loss in the entire filter (“ENTIRE FILTER MEMBER” in FIG. 6) becomes equal to the pressure loss in the first filter layer (“FIRST FILTER LAYER” in FIG. 6) as the time elapses as shown in FIG. 6. At that time, the downstream second to fourth filter layers hardly trap the extraneous matters. Therefore, it is found that the pressure losses in the second to fourth filter layers hardly change (as shown by “SECOND FILTER LAYER”, “THIRD FILTER LAYER” and “FOURTH FILTER LAYER” in FIG. 6). Therefore, the lifetime of the filter is reached when the first filter layer reaches the limit of the clogging.

FIG. 7 shows an experimental result of comparison between the conventional filter and the filter member 2, in which the opening area of the through hole formed in each of the filter layers excluding the fourth filter layer 13 is equivalent to an area of a single through hole having a hole diameter of 4 mm. In the filter member 2, as described above, the filter layers clog in the order from the upstream side to the downstream side in series as the time elapses. The pressure loss in the filtering medium part of the first filter layer 10 excluding the first through hole 101 is smaller than the pressure loss set in the single first through hole 101 having the hole diameter of 4 mm. Therefore, the fuel flows to the filtering medium part of the first filter layer 10 first, and the extraneous matters are trapped by the filtering medium part. Thus, the pressure loss in the filtering medium part increases and the clogging starts in the filtering medium part.

If the pressure loss in the filtering medium part exceeds the pressure loss set in the single first through hole 101, the fuel starts passing through the first through hole 101. The fuel bypasses the filtering medium part of the first filter layer 10 and flows to the second filter layer 11 side. Thereafter, the clogging of the filtering medium part of the first filter layer 10 does not advance, and the pressure loss in the filtering medium part of the first filter layer 10 does not increase largely. The pressure loss in the filtering medium part of the second filter layer 11 excluding the second through hole 111 is smaller than the pressure loss set in the single second through hole 111 having the hole diameter of 4 mm. Therefore, the fuel flowing to the second filter layer 11 side flows to the filtering medium part of the second filter layer 11 first, and the extraneous matters are trapped by the filtering medium part. Thus, the pressure loss in the filtering medium part increases and the clogging starts in the filtering medium part.

If the pressure loss in the filtering medium part exceeds the pressure loss set in the single second through hole 111, the fuel starts passing through the second through hole 111. The fuel bypasses the filtering medium part of the second filter layer 11 and flows to the third filter layer 12 side. However, in the result shown in FIG. 7, the pressure loss in the entire filter member reaches the lifetime pressure loss in a stage where the second filter layer 11 clogs.

As described above, after the first filter layer 10 and the second filter layer 11 clog in this order, the pressure losses in the first and second filter layers 10, 11 do not increase abruptly (at most, 4 kPa or lower). The pressure loss in the entire filter member increases very gently as compared to the experimental result in the case of the conventional filter member having no through hole. Thus, the filter lifetime can be improved.

FIG. 8 shows an experimental result of comparison between the conventional filter and the filter member 2, in which the opening area of the through hole formed in each of the filter layers excluding the fourth filter layer 13 is equivalent to an area of a single through hole having a hole diameter of 5 mm. In the filter member 2, as described above, the filter layers clog in the order from the upstream side to the downstream side in series as the time elapses. The pressure loss in the filtering medium part of the first filter layer 10 excluding the first through hole 101 is smaller than the pressure loss set in the single through hole 101 having the hole diameter of 5 mm. Therefore, the fuel flows to the filtering medium part of the first filter layer 10 first, and the extraneous matters are trapped by the filtering medium part. Thus, the pressure loss in the filtering medium part increases and the clogging starts in the filtering medium part.

If the pressure loss in the filtering medium part exceeds the pressure loss set in the single first through hole 101, the fuel starts passing through the first through hole 101. The fuel bypasses the filtering medium part of the first filter layer 10 and flows to the second filter layer 11 side. Thereafter, the clogging of the filtering medium part of the first filter layer 10 does not advance, and the pressure loss in the filtering medium part of the first filter layer 10 does not increase largely. The pressure loss in the filtering medium part of the second filter layer 11 excluding the second through hole 111 is smaller than the pressure loss set in the second through hole 111 having the hole diameter of 5 mm. Therefore, the fuel having flown to the second filter layer 11 side flows to the filtering medium part of the second filter layer 11 first, and the extraneous matters are trapped by the filtering medium part. Thus, the pressure loss in the filtering medium part increases and the clogging starts in the filtering medium part.

If the pressure loss in the filtering medium part exceeds the pressure loss set in the single second through hole 111, the fuel starts passing through the second through hole 111. The fuel bypasses the filtering medium part of the second filter layer 11 and flows to the third filter layer 12 side. Thereafter, the clogging of the filtering medium part of the second filter layer 11 does not advance, and the pressure loss in the filtering medium part of the second filter layer 11 does not increase largely. The pressure loss in the filtering medium part of the third filter layer 12 excluding the third through hole 121 is smaller than the pressure loss set in the third through hole 121 having the hole diameter of 5 mm. Therefore, the fuel having flown to the third filter layer 12 side flows to the filtering medium part of the third filter layer 12 first, and the extraneous matters are trapped by the filtering medium part. Thus, the pressure loss in the filtering medium part increases and the clogging starts in the filtering medium part.

If the pressure loss in the filtering medium part exceeds the pressure loss set in the single third through hole 121, the fuel starts passing through the third through hole 121. The fuel bypasses the filtering medium part of the third filter layer 12 and flows to the fourth filter layer 13 side. Thereafter, the clogging of the filtering medium part of the third filter layer 12 does not advance, and the pressure loss in the filtering medium part of the third filter layer 12 does not increase largely. Finally, the fuel mainly passes through the first through hole 101, the second through hole 111 and the third through hole 121 in series and filtered by the most downstream fourth filter layer 13.

As described above, after the first filter layer 10, the second filter layer 11 and the third filter layer 12 clog in series, the pressure losses in the first, second and third filter layers 10, 11, 12 do not increase abruptly (at most, 2 kPa or lower). The most downstream fourth filter layer 13 continues to exert the function to remove the extraneous matters until the fourth filter layer 13 clogs (refer to FIG. 8). Therefore, the pressure loss in the entire filter member increases very gently as compared to the experimental result in the case of the conventional filter member having no through hole. Thus, the filter lifetime can be improved.

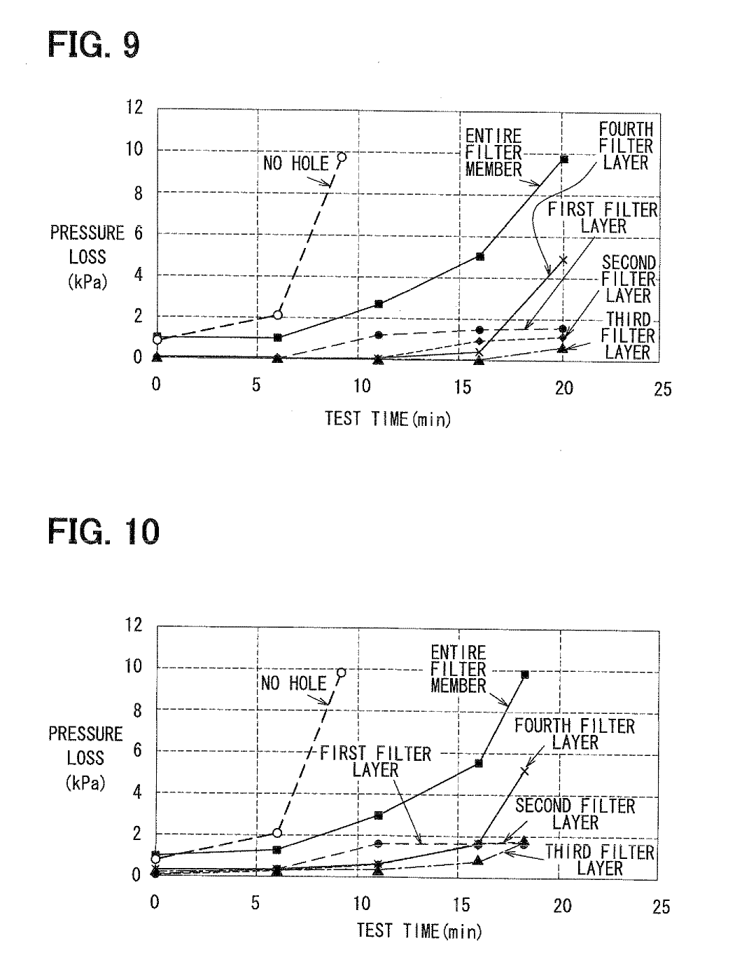

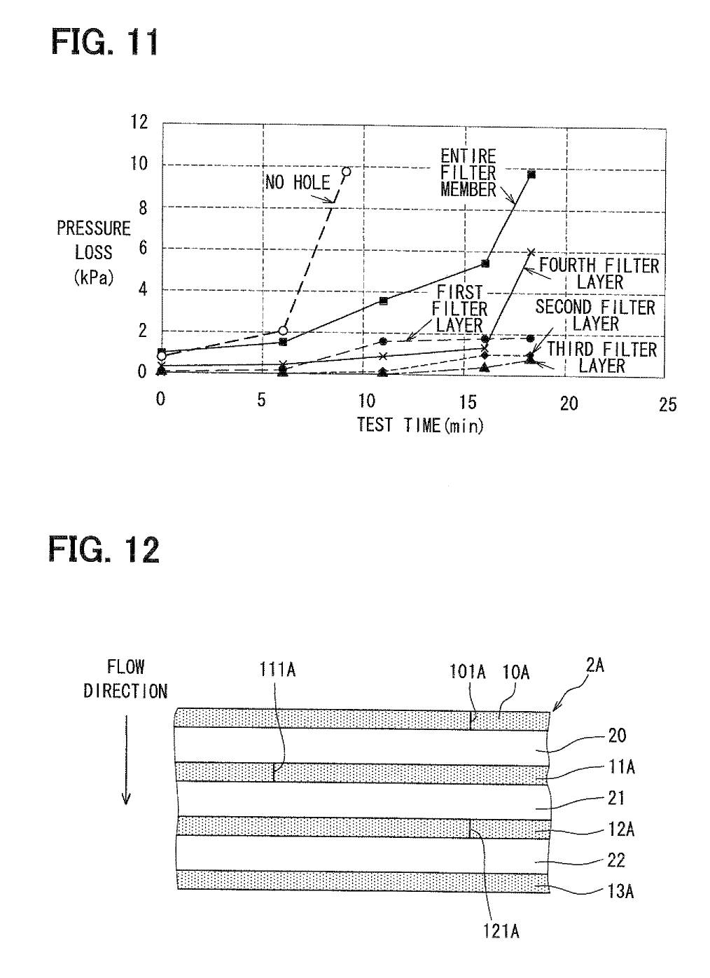

Next, other three forms in the case where the opening area of the through holes formed in each of the filter layers except for the most downstream fourth filter layer 13 is equivalent to an area of a single through hole having a hole diameter of 5 mm will be explained. In first one of the other three forms, the through holes of each filter layer consist of a through hole having a hole diameter of 3 mm and a through hole having a hole diameter of 4 mm. An experimental result of the first form is shown in FIG. 9. In second one of the other three forms, the through holes of each filter layer consist of three through holes each having a hole diameter of 3 mm. An experimental result of the second form is shown in FIG. 10. In third one of the other three forms, the through holes of each filter layer consist of two through holes each having a hole diameter of 3 mm and two through holes each having a hole diameter of 2 mm. An experimental result of the third form is shown in FIG. 11.

The total opening area of the through holes formed in each filter layer of each of the other three forms is somewhat different from the opening area in the case where the single through hole having the hole diameter of 5 mm is formed. However, the pressure loss set by the through hole or holes is substantially the same. The temporal changes of the pressure losses in each of the experimental results shown in FIGS. 9 to 11 are similar to the temporal changes of the pressure losses in the experimental result shown in FIG. 8. As shown in FIGS. 9 to 11, after the first filter layer 10, the second filter layer 11 and the third filter layer 12 clog in series, the pressure losses in the first, second and third filter layers 10, 11, 12 do not increase abruptly (at most, 2 kPa or lower). The most downstream fourth filter layer 13 continues to exert the function to remove the extraneous matters until the fourth filter layer 13 clogs.

The fuel filter device according to the present embodiment has the filter member 2 including the multiple filter layers 10-13 stacked in the thickness direction. In at least one of the filter layers, a through hole set with a larger pressure loss than in the other part of the filter layer is formed. The pressure loss in the through hole is set such that the magnitude relationship between the pressure loss in the through hole and the pressure loss in the other part (filtering medium part) reverses in the process of the accumulation of the passing quantity of the fuel passing through the filter member 2 and the progression of the removal of the extraneous matters.

In such the construction, the filter layer has the through hole as the fuel passing quantity variable section, in which the pressure loss larger than the pressure loss in the other part is set. Therefore, when the fuel passes through the filter member 2 in an initial stage, it is difficult for the fuel to pass through the through hole set with the large pressure loss and it is easy for the fuel to pass through the other part than the through hole. Therefore, the fuel is filtered and the extraneous matters are removed in the other part.

The pressure loss in the through hole is set at the value, with which the magnitude relationship between the pressure loss in the through hole and the pressure loss in the other part reverses in the process of the accumulation of the passing quantity of the fuel and the progression of the removal of the extraneous matters. With such the construction, the pressure loss in the other part exceeds the pressure loss in the through hole as the clogged state of the other part of the filter layer progresses. If such the state occurs, it becomes difficult for the fuel to pass through the other part where the pressure loss has increased, and then the fuel begins to pass through the through hole and flow to the downstream filter layer side.

If the clogging of the other part progresses in the filter layer having the through hole in this way, the fuel passes through the through hole at the timing when the magnitude relationship between the pressure loss in the other part and the pressure loss in the through hole reverses. Thereafter, the downstream filter layer starts to exert the extraneous matter trapping ability in place of the upstream filter layer. Thus, the extraneous matter trapping abilities of the respective filter layers can be utilized in series, and the filtration fully utilizing the respective filter layers can be performed. Therefore, the filtration area of the filter member can be reduced. Accordingly, the body size of the device can be suppressed and the lifetime of the filter can be improved.

The filter member 2 has the gaps among the filter layers, which are adjacent to each other in the thickness direction. Each of the through holes 101,111,121 has the predetermined opening area satisfying the above-mentioned pressure loss. The above construction may be formed by calculating an opening area that satisfies the condition that the pressure loss in the through hole is larger than the pressure loss in the other part while the clogging has not occurred in the filter layer in the process of the progression of the filtration and that the magnitude relationship of the pressure loss reverses in a predetermined stage of clogging and by forming the through hole having a size satisfying the calculated opening area. Therefore, the above-described fuel passing quantity variable section to be formed can be decided relatively easily and can be formed easily.

Since the pressure loss satisfied by each of the through holes 101,111,121 resides in the range from 1.5 kPa to 4 kPa, the above-mentioned effect can be expected when the filter device according to the present invention is used as a filter device for filtering the fuel such as the gasoline or the light oil.

The through holes 101, 111, 121 are formed in the positions deviated from each other in the direction perpendicular to the thickness direction between the filter layers adjacent to each other in the thickness direction such that the through holes do not overlap with each other between the adjacent filter layers in the thickness direction.

With such the construction, the through holes 101,111,121 of the filter layers adjacent to each other in the thickness direction are distanced from each other between the adjacent filter layers in the direction perpendicular to the thickness direction. Therefore, the fuel having passed through the through holes 101,111 in the upstream filter layers is certainly filtered by the downstream filter layers. After the downstream filter layers clog, the fuel starts to pass through the through holes 111, 121 in the downstream filter layers. Thus, the extraneous matter trapping abilities of the filtering medium parts of the downstream filter layers can be fully exerted. Accordingly, the extraneous matter trapping abilities of the multiple filter layers can be utilized, and the lifetime of the filter can be surely extended.

### Second Embodiment

Next, other forms of the filter member 2 will be explained as a second embodiment of the present invention with reference to FIGS. 12 to 22. FIG. 12 is a schematic cross-sectional view showing a construction of a filter member 2A applied to a fuel filter device according to the second embodiment. Each of component parts denoted with the same sign as the first embodiment is the same as the first embodiment and exerts effects similar to the effects of the first embodiment. The other construction of the fuel filter device according to the second embodiment than the filter member 2A is the same as the fuel filter device according to the first embodiment and exerts effects similar to the effects of the first embodiment.

FIG. 12 is a schematic cross-sectional view showing the construction of the filter member 2A. As shown in FIG. 12, the filter member 2A is constituted by four nonwoven fabric layers consisting of a first filter layer 10A, a second filter layer 11A, a third filter layer 12A and a fourth filter layer 13A stacked in this order from an outside to an inside in a thickness direction. The thickness direction coincides with a fuel flow direction. In the present embodiment, fine void parts are formed in the respective filter layers. The filter layers are nonwoven fabric layers having substantially equal void ratios. The void ratio is a ratio of the void parts to the total volume of the filter layer. However, using the nonwoven fabric layers having the specified void ratio as the respective filter layers is not a prerequisite for exerting the effects of the fuel filter device according to the present invention. That is, the multiple filter layers 10A-13A may have the same void ratio. Alternatively, a density gradient in the thickness direction of the filter member 2A may be set by providing differences among the void ratios of the respective filter layers.

The void ratios of the respective filter layers 10A-13A can be set by setting wire diameters of the fibers constituting the respective nonwoven fabric layers at predetermined values. For example, when the dense layer is formed by reducing the void ratio, the dense layer can be formed by using the fiber having the small wire diameter. When the coarse layer is formed by increasing the void ratio, the course layer can be formed by using the fiber having the large wire diameter. In the present embodiment, the fiber constituting the respective filter layers 10A-13A is made of a PET resin (polyethylene terephthalate resin) or a polyamide type resin having high oil resistance. The nonwoven fabric can be manufactured by the dry method, the spunbond method, the meltblown method, the wet method or the like, for example.

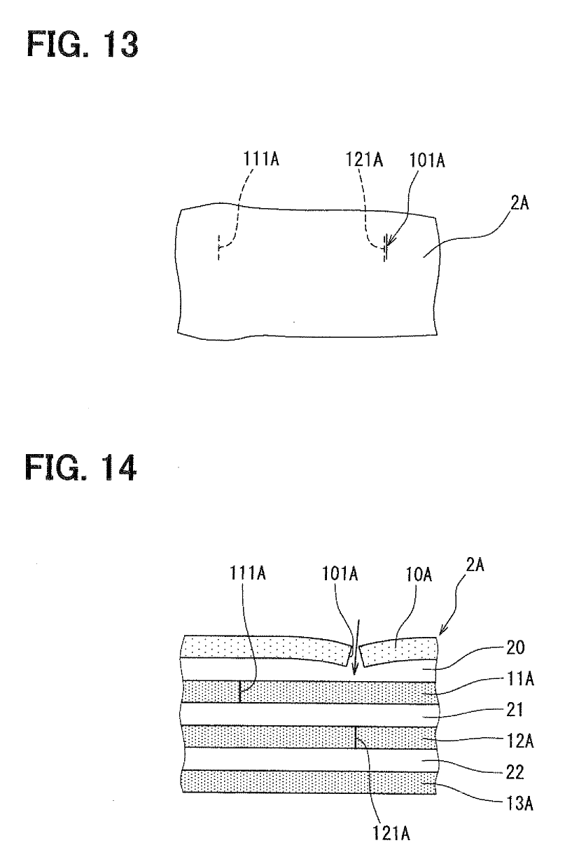

A first cut section 101A is beforehand formed in the outermost first filter layer 10A. A second cut section 111A is beforehand formed in a second filter layer 11A, which is arranged inside the first filter layer 10A across a gap 20. The second cut section 111A is formed in a position, which is distanced from the position of the first cut section 101A along a direction perpendicular to the fuel flow direction. A third cut section 121A is beforehand formed in a third filter layer 12A, which is arranged inside the second filter layer 11A across a gap 21. The third cut section 121A is formed in a position, which is distanced from the position of the second cut section 111A along the direction perpendicular to the fuel flow direction. No cut section is formed in the innermost fourth filter layer 13A. Each of the cut sections 101A, 111A, 121A serves as an opening area variable section that enlarges and opens when corresponding one of the filter layers 10A-13A bends. Each of the cut sections 101A, 111A, 121A is a cut or a very narrow slit penetrating through corresponding one of the nonwoven fabric filter layers 10A, 11A, 12A. For example, when the filter member 2A is shown in a plan view as in FIG. 13, the cut section is formed in the shape of a line.

The respective filter layers 10A-13A are arranged such that the gaps are formed among the filter layers adjacent to each other. More specifically, the gap 20 is formed between the first filter layer 10A and the second filter layer 11A. The gap 21 is formed between the second filter layer 11A and the third filter layer 12A. The gap 22 is formed between the third filter layer 12A and the fourth filter layer 13A. The outermost first filter layer 10A serves as the most upstream layer, and the innermost fourth filter layer 13A serves as the most downstream layer. Therefore, the fuel passing through the filter member 2A flows to pass through the outermost first filter layer 10A, the gap 20, the second filter layer 11A, the gap 21, the third filter layer 12A, the gap 22 and the innermost fourth filter layer 13A in series as shown by an arrow mark (flow direction) in FIG. 12.

In the process of the progression of the filtration of the fuel in the filter member 2A, each of the cut sections 101A, 111A, 121A functions as a fuel passing quantity variable section that changes from a state where it is difficult for the fuel to pass through the fuel passing quantity variable section to a state where the passing quantity of the fuel increases. Therefore, each of the cut sections 101A, 111A, 121A is beforehand formed to provide a pressure loss larger than a pressure loss in the other part of corresponding one of the filter layers 10A, 11A, 12A (i.e., filtering medium part). Moreover, the pressure loss in each of the cut sections 101A, 111A, 121A is set at a value, with which a magnitude relationship between the pressure loss in the cut section and the pressure loss in the other part (i.e., filtering medium part) reverses in the process of the accumulation of the passing quantity of the fuel passing through the filter member 2A and the progression of the removal of the extraneous matters.

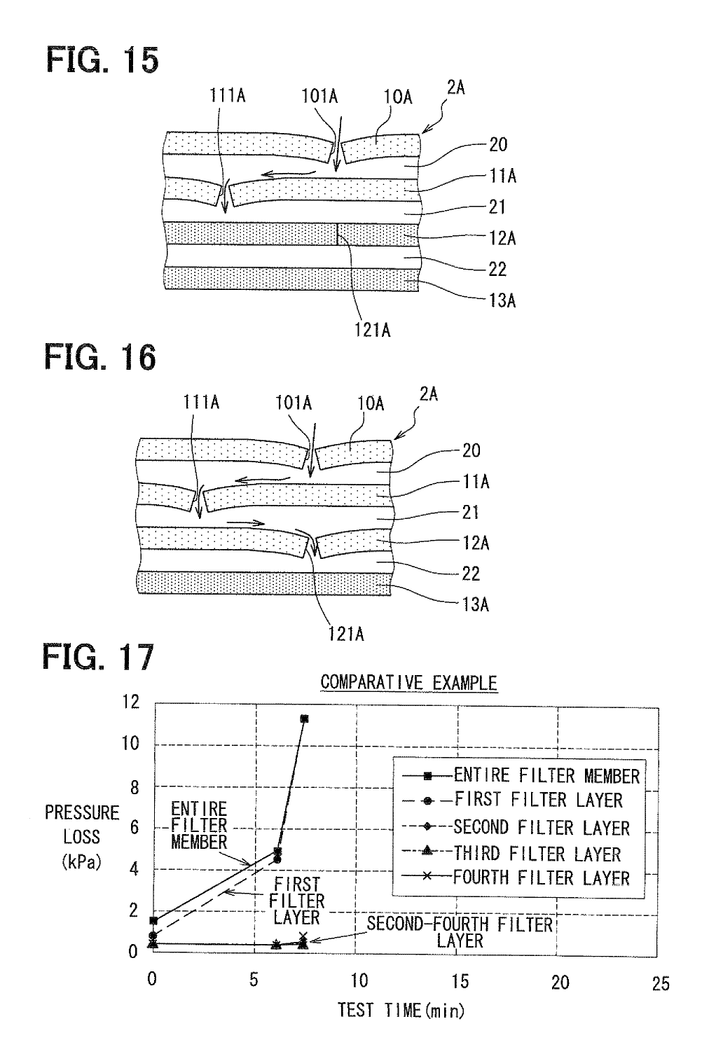

Next, a mechanism for trapping the extraneous matters when the fuel passes through the filter member 2A in the thickness direction will be explained with reference to FIGS. 14 to 16. FIG. 14 is a partial cross-sectional view showing a state where the outermost first filter layer 10A is bent by the fuel pressure and the cut section 101A enlarges and opens to form a through hole in the filter member 2A. FIG. 15 is a partial cross-sectional view showing a state where the second filter layer 11A inside the first filter layer 10A is bent by the fuel pressure after the first filter layer 10A is bent as shown in FIG. 14, so the cut section 111A enlarges and opens to form a through hole. FIG. 16 is a partial cross-sectional view showing a state where the third filter layer 12A inside the second filter layer 11A is bent by the fuel pressure after the second filter layer 11A is bent as shown in FIG. 15, so the cut section 121A enlarges and opens to form a through hole.

If time passes after the fuel begins to pass through the filter member 2A, the extraneous matters contained in the fuel are trapped by the outermost first filter layer 10A first. If the trapping of the extraneous matters in the first filter layer 10A progresses further and the first filter layer 10A is clogged as shown in FIG. 14, differential pressure between an upstream space and a downstream space (i.e., gap 20) of the first filter layer 10A increases. Because of the differential pressure, the first filter layer 10A receives flow pressure of the fuel and is deformed and bent. As a result, the cut section 101A opens widely. Thus, the through hole penetrating through the filtering medium in the thickness direction is formed in the first filter layer 10A when the cut section 101A enlarges and opens. Therefore, it becomes easier for the fuel to pass through the through hole defining the pressure loss smaller than the pressure loss defined by the fine void parts formed in the entire first filter layer 10A.

As the fuel passes through the through hole, the extraneous matters in the fuel are not trapped in the void parts of the first filter layer 10A but begin to flow into the gap 20 and the second filter layer 11A via the through hole. Therefore, further progression of the clogging of the first filter layer 10A becomes difficult. The fuel having passed through the through hole formed in the first filter layer 10A passes through the gap 20, the second filter layer 11A, the gap 21, the third filter layer 12A, the gap 22, and the fourth filter layer 13A in series. The extraneous matters are trapped by the second filter layer 11A.

If the trapping of the extraneous matters in the second filter layer 11A progresses further and the second filter layer 11A clogs as shown in FIG. 15 as the time elapses further, the differential pressure between the upstream gap 20 and the downstream gap 21 of the second filter layer 11A increases. Because of the differential pressure, the second filter layer 11A receives flow pressure of the fuel and is deformed and bent. As a result, the cut section 111A opens widely. Thus, a through hole penetrating through the filtering medium in the thickness direction is formed in the second filter layer 11A when the cut section 111A enlarges and opens. Therefore, it becomes easier for the fuel to pass through the through hole defining the pressure loss smaller than the pressure loss defined by the fine void parts formed in the entire second filter layer 11A.

As the fuel passes through the through hole, the extraneous matters in the fuel are not trapped in the void parts of the second filter layer 11A but begin to flow into the gap 21 and the third filter layer 12A via the through hole. Therefore, further progression of the clogging of the second filter layer 11A becomes difficult. The fuel having passed through the through hole formed in the second filter layer 11A passes through the gap 21, the third filter layer 12A, the gap 22, and the fourth filter layer 13A in series. The extraneous matters are trapped by the third filter layer 12A.

If the trapping of the extraneous matters in the third filter layer 12A progresses further and the third filter layer 12A is clogged as shown in FIG. 16 when the time elapses further, the differential pressure between the upstream gap 21 and the downstream gap 22 of the third filter layer 12A increases. Because of the differential pressure, the third filter layer 12A receives flow pressure of the fuel and is deformed and bent. As a result, the cut section 121A opens widely. Thus, a through hole penetrating through the filtering medium in the thickness direction is formed in the third filter layer 12A when the cut section 121A enlarges and opens. Therefore, it becomes easier for the fuel to pass through the through hole defining the pressure loss smaller than the pressure loss defined by the fine void parts formed in the entire third filter layer 12A.

As the fuel passes through the through hole, the extraneous matters in the fuel are not trapped in the void parts of the third filter layer 12A but begin to flow into the gap 22 and the fourth filter layer 13A via the through hole. Therefore, further progression of the clogging of the third filter layer 12A becomes difficult. The fuel having passed through the through hole formed in the third filter layer 12A passes through the gap 22 and the fourth filter layer 13A. The extraneous matters are trapped by the fourth filter layer 13A. If the trapping of the extraneous matters in the fourth filter layer 13A progresses and the fourth filter layer 13A clogs as the time passes further, all the filter layers clog. Accordingly, the filter member 2A cannot exert the extraneous matter removing function anymore. In such the state, the filter member 2A eventually reaches its filter lifetime. Accordingly, the useful life can be improved.

Next, experimental results of comparison of the temporal changes of the pressure losses between the conventional filter member and the filter member 2A according to the present embodiment will be explained. In the following experimental results, the fuel is the light oil containing predetermined dust, and the flow rate of the fuel is 60 liters per hour. Four filter layers have thickness of 0.4 mm to 0.5 mm each and substantially the same void ratio. The gap formed between the filter layers in the experiment of FIG. 19 is 20 mm. A pressure loss in the entire filter member is calculated from differential pressure between an upstream side of the first filter layer and a downstream side of the fourth filter layer. A pressure loss in each layer is calculated from differential pressure between an upstream side and a downstream side of the layer.

FIG. 17 shows an experimental result indicating temporal changes of the pressure losses in the entire filter and the respective filter layers in a case of a conventional filter consisting of four filter layers formed with no cut section (slit). In this conventional filter member, if the extraneous matters in the fuel are trapped by the outermost first filter layer and the first filter layer reaches a clogged state first, it becomes difficult for the first filter layer to trap the extraneous matters further. Therefore, the pressure loss in the entire filter becomes equal to the pressure loss in the first filter layer as the time elapses as shown in FIG. 17. Since the downstream second to fourth filter layers do not trap the extraneous matters, the pressure losses in the second to fourth filter layers hardly change. Therefore, improvement of the filter lifetime cannot be expected.

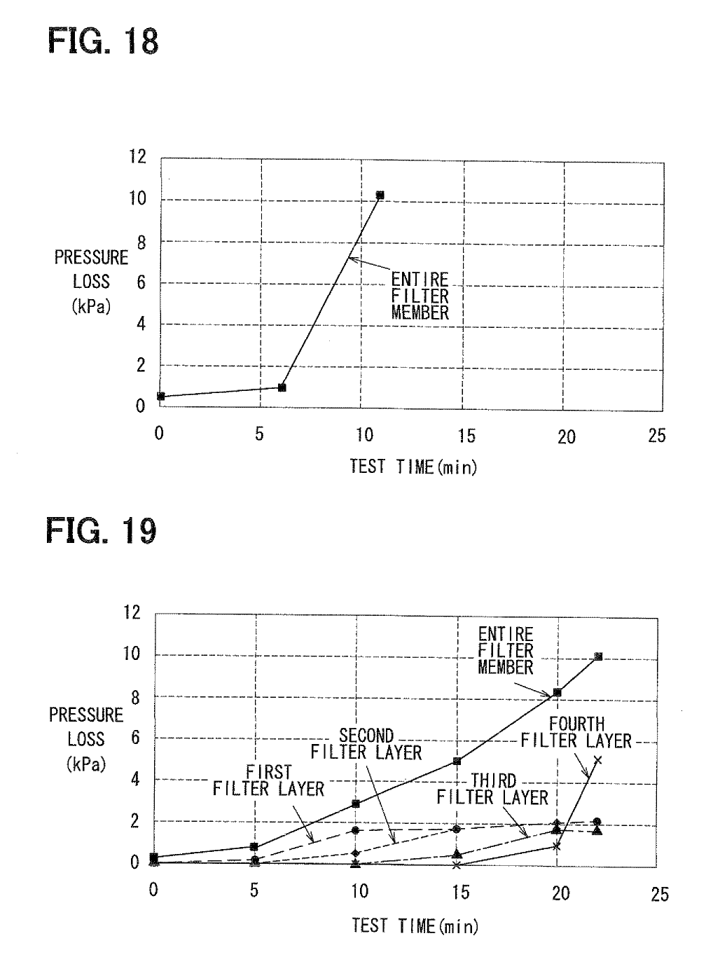

FIG. 18 shows an experimental result indicating a temporal change of a pressure loss in an entire filter, in which cut sections (slits) each having length of 15 mm are formed in respective filter layers and the filter layers are stacked in the thickness direction to closely contact each other without providing a gap between the adjacent filter layers. In this filter member, if the extraneous matters in the fuel are trapped by the outermost first filter layer and the first filter layer is clogged with the extraneous matters first, the extraneous matters contained in the fuel slightly flow into the downstream second filter layer through the cut section (slit) having the length of 15 mm. Therefore, the increase of the pressure loss in the initial stage can be inhibited as compared to the case of the experiment result shown in FIG. 17. However, since no gap is formed between the filter layers unlike the filter member 2A of the present embodiment, it is difficult for the cut section (slit) to enlarge and open as in the filter member 2A described above. Therefore, the pressure loss increases abruptly thereafter, so the improvement of the filter lifetime cannot be expected.

FIG. 19 shows an experimental result indicating temporal changes of the pressure losses in the entire filter and the respective filter layers of the filter member 2A according to the present embodiment. In the filter member 2A, as described above, the filter layers clog in the order from the upstream side to the downstream side as the time elapses. The cut section (slit) having the length of 15 mm enlarges and opens due to the deformation caused by the increase of the pressure loss accompanying the clogging of each of the filter layers. Thus, the through holes, through which the extraneous matters can pass, are formed downstream in the respective filter layers in series. Therefore, as shown in FIG. 19, the pressure losses in the first to third filter layers do not increase abruptly after the first to third filter layers clog in series. At that time, the most downstream fourth filter layer continues to exert the extraneous matter removing function until the fourth filter layer clogs. Therefore, the pressure loss in the entire filter increases very gently as compared to the experimental results shown in FIGS. 17 and 18. Accordingly, the improvement in the filter lifetime can be expected.

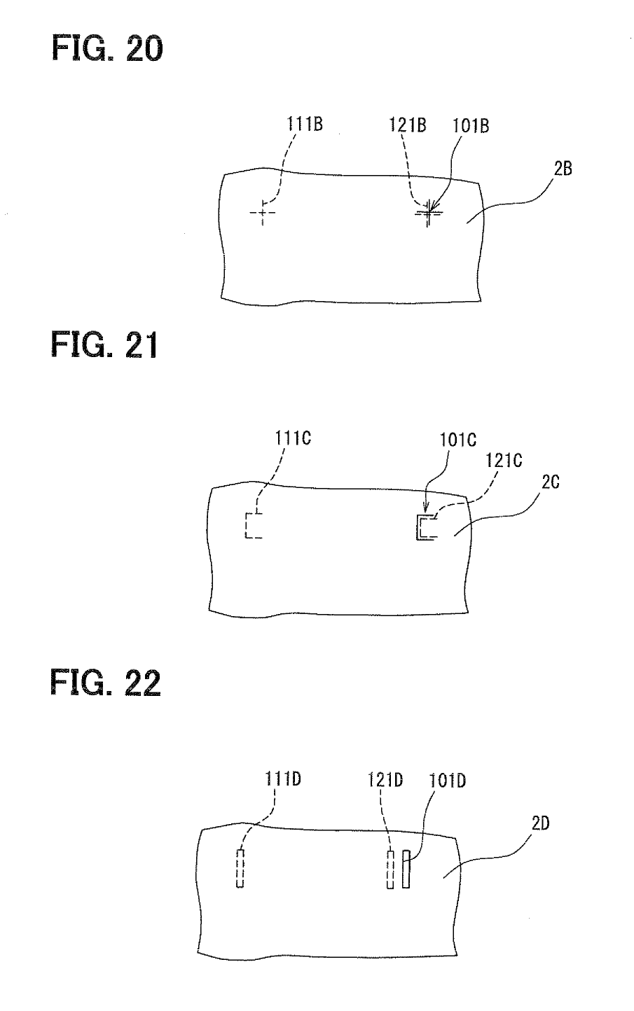

The shapes of the cut sections 101A, 111A, 121A formed in the respective filter layers 10A, 11A, 12A are not limited to the above-described shapes shown in FIG. 13 as long as each of the filter layers can have a function to deform to enlarge and open the cut section when the filter layer receives the flow pressure of the fuel due to the increase of the pressure loss accompanying the clogging of the filter layer with the extraneous matters. Therefore, the opening area variable section that enlarges and opens when the filter layer bends may be formed in shapes shown in first to third modifications shown in FIGS. 20 to 22, for example.

Cross-like cut sections 101B, 111B, 121B are formed in a filter member 2B of the first modification shown in FIG. 20. Each of the cut sections 101B, 111B, 121B is formed by piercing the filter layer by using a member having a cross-like cutting tooth, for example. With such the shape, if the filter layer receives the flow pressure of the fuel and deforms toward the downstream gap side due to the clogging, a central portion of the cross-like cut section opens widely. Therefore, the fuel containing the extraneous matters can flow to the downstream filter layers. The extraneous matters are trapped in the downstream filter layers, so the filter lifetime can be improved.

Cut sections 101C, 111C, 121C, each of which is formed in a U-shape having right-angled corners, are formed in a filter member 2C of the second modification shown in FIG. 21. Each of the cut sections 101C, 111C, 121C is formed by piercing the filter layer by using a member having a cutting tooth in a U-shape having right-angled corners, for example. With such the shape, if the filter layer receives the flow pressure of the fuel and deforms toward the downstream gap side due to the clogging, a portion of the cut section between the right-angled corners opens largely. Also in this case, the fuel containing the extraneous matters can flow to the downstream filter layers. The extraneous matters are trapped by the downstream filter layers, so the filter lifetime can be improved.

Slender rectangular slits 101D, 111D, 121D penetrating through respective filter layers are formed in a filter member 2D of the third modification shown in FIG. 22. Each of the cut sections 1010, 111D, 121D is formed by punching the filter layer by using a punch member in a predetermined rectangular shape, for example. With such the shape, if the filter layer receives the flow pressure of the fuel and deforms toward the downstream gap side due to the clogging, the slit opens to widen. Also in this case, the fuel containing the extraneous matters can flow to the downstream filter layers. The extraneous matters are trapped by the downstream filter layers, so the filter lifetime can be improved.

In the fuel filter device according to the present embodiment, the suction filter 1 has the filter member 2A including the multiple filter layers 10A-13A stacked in the thickness direction. The suction filter 1 removes the extraneous matters from the fuel when the fuel passes through the filter member 2A in the thickness direction. The filter member 2A defines the gap 20 between the filter layers 10A, 11A adjacent to each other in the thickness direction. The opening area variable section, which enlarges and opens when the filter layer bends, is formed in at least one (e.g., first filter layer 10A) of the multiple filter layers 10A-13A. The opening area variable section enlarges and opens when the filter layer bends toward the downstream filter layer side with respect to the fuel flow direction due to the flow pressure at the time when the fuel flows. Thus, the opening area variable section forms the through hole penetrating through the filter layer.

With such the construction, for example, when the clogging of the first filter layer 10A progresses to a certain degree, the differential pressure between the upstream side and the downstream side of the filter layer increases. Therefore, the first filter layer 10A deforms and bends toward the downstream gap 20 side due to the flow pressure of the fuel. Due to the deformation, the opening area variable section beforehand formed in the first filter layer 10A enlarges and opens to form the through hole penetrating through the first filter layer 10A. Therefore, the fuel passes through the opening area variable section having enlarged and opened and is filtered by the downstream second filter layer 11A rather than passing through the void parts of the first filter layer 10A having clogged already. In this way, if the first filter layer 10A approaches the upper limit of the extraneous matter trapping ability, the fuel passes through the opening area variable section, and the downstream second filter layer 11A begins to exert the extraneous matter trapping ability. Accordingly, the extraneous matter trapping abilities of the respective filter layers can be fully utilized. Thus, the lifetime of the filter can be extended and the filtration area can be reduced.

Conventionally, in order to substantially equalize the clogged states of the respective filter layers and to extend the lifetime of the filter, the density gradient of the filter member in the fuel flow direction has been set finely or the number of the stacked layers of the filter layers has been increased, for example. As contrasted thereto, the fuel filter device according to the present invention can extend the lifetime of the filter without forming the filter member having the effective density gradient, which is difficult to realize.

The filter member 2A has the opening area variable sections in all the filter layers 10A-12A except for the fourth filter layer 13A located on the most downstream side with respect to the fuel flow direction. With such the construction, if the clogging of the filter layers 10A-12A progresses to a certain degree, the filter layers 10A-12A deform and bend toward the downstream gaps 20, 21, 22 due to the flow pressure of the fuel. Due to the deformation, the opening area variable sections beforehand provided in the respective filter layers 10A-12A enlarge and open to form the through holes penetrating through the respective filter layers 10A-12A. Therefore, the fuel passes through the opening area variable sections having enlarged and opened and is filtered by the downstream filter layer rather than passing through the void parts of the filter layers 10A-12A having already clogged. In this way, if the upstream filter layer approaches the upper limit of the extraneous matter trapping ability, the fuel passes through the enlarged opening area variable section, and the downstream filter layer begins to exert the extraneous matter trapping ability. This action occurs in all the filter layers beforehand formed with the opening area variable sections. Therefore, the filter lifetime can be extended by the number of the stacked filter layers. Thus, the fuel filter device capable of further suppressing the body size of the device and improving the filter lifetime can be provided.

The opening area variable sections are the cut sections in the shapes of lines, the crosses or the U-shapes with the right-angled corners or the rectangular slits penetrating through the filter layers 10A-12A respectively. With such the constructions, the opening area variable sections for extending the filter lifetime can be formed easily by press working or the like. Therefore, the fuel filter device having high processability and productivity can be provided.

The opening area variable sections are respectively provided at the deviated positions in the filter layers 10A, 11A, which are adjacent to each other in the thickness direction, such that the opening area variable sections do not overlap in the thickness direction between the filter layers 10A, 11A. In such the construction, the opening area variable sections respectively provided in the filter layers 10A, 11A, which are adjacent to each other in the thickness direction, are distanced from each other in the direction perpendicular to the thickness direction such that the opening area variable sections do not overlap with each other in the thickness direction. Therefore, the fuel having passed through the upstream opening area variable section having enlarged and opened is surely filtered by the void parts of the downstream filter layer 11A. After the downstream filter layer 11A clogs, the fuel begins to pass through the downstream opening area variable section having enlarged and opened. In this way, the extraneous matter trapping ability can be fully exerted in the downstream filter layer 11A. Accordingly, the lifetime of the filter can be surely extended.

### Third Embodiment

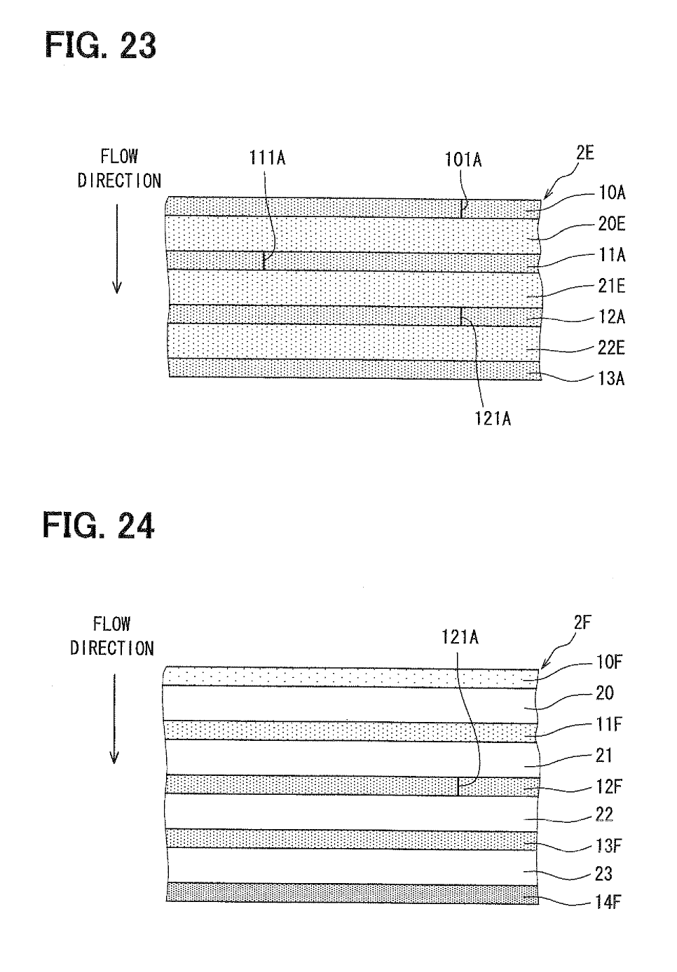

Next, a filter member 2E according to a third embodiment of the present invention will be explained with reference to FIG. 23. FIG. 23 is a schematic cross-sectional view showing a filter member 2E applied to a fuel filter device according to the third embodiment. Each component part in FIG. 23 denoted by the same sign as the second embodiment is the same as the component part in the second embodiment and exerts effects similar to the effects of the second embodiment. The other construction of the fuel filter device according to the third embodiment than the filter member 2E is the same as the fuel filter device of the second embodiment and exerts effects similar to the effects of the second embodiment.

As shown in FIG. 23, in the filter member 2E of the third embodiment, middle layers having a larger void ratio (i.e., being coarser) than the filter layers 10A-13A are provided among the filter layers 10A-13A instead of the gaps unlike the filter member 2A of the second embodiment (shown in FIG. 12). That is, a first middle layer 20E is provided between the first filter layer 10A and the second filter layer 11A. A second middle layer 21E is provided between the second filter layer 11A and the third filter layer 12A. A third middle layer 22E is provided between the third filter layer 12A and the fourth filter layer 13A. The middle layers 20E, 21E, 22E are coarse to an extent that the extraneous matters in the fuel can pass through the middle layers 20E, 21E, 22E. Therefore, a passage resistance in the middle layers 20E, 21E, 22E is smaller than in the filter layers 10A-13A, and the fuel can easily pass through the middle layers 20E, 21E, 22E. Each of the middle layers 20E, 21E, 22E is sandwiched between the two filter layers from the both sides and exerts a function as a spacer layer to maintain an interval between the filter layers.

The mechanism for trapping the extraneous matters when the fuel passes through the filter member 2E in the thickness direction is similar to the mechanism according to the second embodiment. That is, the first filter layer 10A, the second filter layer 11A and the third filter layer 12A deform due to the flow pressure of the fuel in this order in the flow direction of the fuel and the cut sections of the first to third filter layers 10A, 11A, 12A enlarge and open in this order.

Next, the above construction will be explained by using the first filter layer 10A as a representing example. If the passage of the fuel to the filter member 2E progresses and the first filter layer 10A clogs, the differential pressure between the upstream space and the downstream space (first middle layer 20E) of the first filter layer 10A increases. Accordingly, the first filter layer 10A receives flow pressure of the fuel and deforms and bends toward the downstream first middle layer 20E side, so the cut section 101A opens widely. The first middle layer 20E is the coarse layer having the larger void ratio than the filter layer and is not a hard layer. Therefore, the upstream first filter layer 10A can deform. In this way, the through hole penetrating through the filtering medium in the thickness direction is formed in the first filter layer 10A when the cut section 101A enlarges and opens. Therefore, it becomes easier for the fuel to pass through the through hole defining the pressure loss smaller than the pressure loss defined by the void parts formed in the entire first filter layer 10A.

As the fuel passes through the through hole, the extraneous matters in the fuel are not trapped in the void parts of the first filter layer 10A but begin to flow into the first middle layer 20E and the second filter layer 11A via the through hole. Therefore, further progression of the clogging in the first filter layer 10A becomes difficult. The fuel having passed through the through hole generated in the first filter layer 10A passes through the first middle layer 20E, the second filter layer 11A, the second middle layer 21E, the third filter layer 12A, the third middle layer 22E and the fourth filter layer 13A in series. The extraneous matters are trapped by the second filter layer 11A.

Like the first filter layer 10A, the cut sections of the second and third filter layers 11A, 12A enlarge and open to form the through holes when the clogging progresses in the second and third filter layers 11A, 12A. The fuel having passed through the through holes begins to flow to the downstream layers.

In the fuel filter device according to the present embodiment, the filter member 2E has a construction in which the first middle layer 20E having the larger void ratio than the filter layers 10A, 11A is interposed between the filter layers 10A, 11A adjacent to each other in the thickness direction. At least in the first filter layer 10A among the multiple filter layers 10A-13A, the opening area variable section, which enlarges and opens when the first filter layer 10A bends, is formed. If the first filter layer 10A bends toward the downstream second filter layer 11A side due to the flow pressure at the time when the fuel flows, the opening area variable section enlarges and opens to form the through hole penetrating through the first filter layer 10A.

With such the construction, if the clogging of the first filter layer 10A progresses to a certain degree, the differential pressure between the upstream side and the downstream side of the first filter layer 10A increases. In such the case, due to the flow pressure of the fuel, the first filter layer 10A deforms and bends toward the downstream first middle layer 20E, which is relatively soft. Due to the deformation, the opening area variable section beforehand provided in the first filter layer 10A enlarges and opens to form the through hole penetrating through the first filter layer 10A. Therefore, the fuel begins to pass through the opening area variable section having enlarged and opened and is filtered by the downstream second filter layer 11A rather than passing through the void parts of the first filter layer 10A having already clogged. In this way, if the first filter layer 10A approaches the upper limit of the extraneous matter trapping ability, the fuel passes through the enlarged opening area variable section, and the downstream second filter layer 11A begins to exert the extraneous matter trapping ability. Accordingly, the extraneous matter trapping abilities of the respective filter layers can be fully utilized. Thus, the lifetime of the filter can be extended and the filtration area can be reduced.

### Fourth Embodiment

Next, a filter member 2F according to a fourth embodiment of the present invention will be explained with reference to FIG. 24. FIG. 24 is a schematic cross-sectional view showing the filter member 2F applied to a fuel filter device according to the fourth embodiment. Each component part in FIG. 24 denoted by the same sign as in the second embodiment is the same as the component part in the second embodiment and exerts effects similar to the effects of the second embodiment. The other construction of the fuel filter device according to the fourth embodiment than the filter member 2F is the same as the fuel filter device of the second embodiment and exerts effects similar to the effects of the second embodiment.

Unlike the filter member 2A according to the second embodiment (refer to FIG. 12), the filter member 2F according to the fourth embodiment has multiple filter layers having different void ratios. With such the construction, the filter member 2F has a density gradient in the thickness direction (i.e., in fuel flow direction), thereby forming a gradient of the filtering ability in the thickness direction. As shown in FIG. 24, the filter member 2F is constituted by five nonwoven fabric layers consisting of a first filter layer 10F, a second filter layer 11F, a third filter layer 12F, a fourth filter layer 13F and a fifth filter layer 14F, which are stacked in this order from an outside to an inside in the thickness direction (i.e., fuel flow direction).

Void ratios of the respective filter layers 10E-14F are set individually by setting wire diameters of fibers constituting the respective nonwoven fabric layers at predetermined values. The void ratios of the respective filter layers 10E-14F are set such that the void ratio decreases in the order of the first filter layer 10F, the second filter layer 11F, the third filter layer 12F, the fourth filter layer 13F and the fifth filter layer 14F. The fiber constituting the respective filter layers 10E-14F is made of a PET resin (polyethylene terephthalate resin) or a polyamide type resin having high oil resistance. Each void ratio can be set by selecting the wire diameter of the fiber constituting the nonwoven fabric layer.

The respective filter layers 10E-14F are arranged such that gaps are formed among the respective adjacent layers. More specifically, a gap 20 is formed between the first filter layer 10F and the second filter layer 11F. A gap 21 is formed between the second filter layer 11F and the third filter layer 12F. A gap 22 is formed between the third filter layer 12F and the fourth filter layer 13F. A gap 23 is formed between the fourth filter layer 13F and the fifth filter layer 14F. The outermost first filter layer 10F serves as the most upstream layer, and the innermost fifth filter layer 14F serves as the most downstream layer. Therefore, the fuel passing through the filter member 2F flows to pass through the outermost first filter layer 10F, the gap 20, the second filter layer 11F, the gap 21, the third filter layer 12F, the gap 22, the fourth filter layer 13F, the gap 23 and the innermost fifth filter layer 14F in series as shown by an arrow mark in FIG. 24 (flow direction).

Among the extraneous matters in the fuel, the matters having relatively large sizes are trapped by the first filter layer 10F that is the coarsest layer. Then, the matters that have relatively large sizes and that cannot be trapped by the first filter layer 10 are trapped by the second filter layer 11F that is the second coarsest layer. Then, the matters having sizes that cannot be trapped by the second filter layer 11F are trapped by the third and fourth filter layers 12F, 13F having the same void ratio. Finally, the remaining extraneous matters having small sizes are trapped by the fifth filter layer 14F that is the densest layer.

In the filter member 2F, the cut section similar to the cut section according to the second embodiment is formed in the filter layer, in which the extraneous matters are trapped most easily and the clogging tends to occur early. In the present embodiment, because of the construction of the layers of the filter member 2F, the cut section 121A is formed in the third filter layer 12F. If the clogging of the third filter layer 12F progresses, the third filter layer 12F deforms toward the gap 22 side due to the flow pressure of the fuel, and the cut section 121A of the third filter layer 12F enlarges and opens. The fuel does not pass through the void parts of the third filter layer 12F, which has clogged and has increased the pressure loss, but flows into the downstream fourth filter layer 13F via the cut section 121A having enlarged and opened. Thus, further progression of the clogging of the third filter layer 12F can be inhibited. The extraneous matters that cannot be trapped by the third filter layer 12F, whose extraneous matter trapping ability has been exceeded due to the clogging, can be trapped by the fourth filter layer 13F having the same extraneous matter trapping ability as the third filter layer 12F. Therefore, the lifetime of the filter member 2F can be extended until the extraneous matter trapping ability of the fourth filter layer 13F is reached.

In the fuel filter device according to the present embodiment, the cut section 121A as the opening area variable section is formed in the third filter layer 12F that has the smallest void ratio among the filter layers except for the fifth filter layer 14F arranged on the most downstream side with respect to the fuel flow direction. According to such the construction, the opening area variable section is formed in the third filter layer 12F, which is upstream of the most downstream fifth filter layer 14F and which starts clogging early among the multiple filter layers 10E-14F. Therefore, even if the clogging of the third filter layer 12F occurs, the extraneous matters can be trapped by the downstream fourth filter layer 13F. Accordingly, the fuel filter device capable of extending the lifetime of the entire filter member 2F can be provided.

### Fifth Embodiment

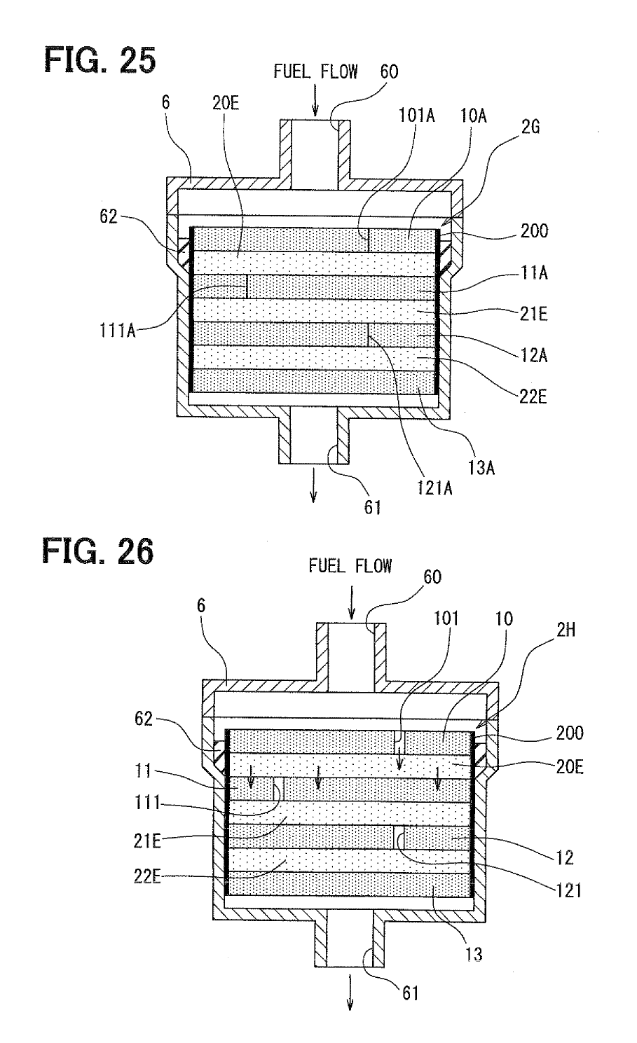

Next, a fifth embodiment of the present invention will be described. The fifth embodiment is another form of a fuel filter device, to which the present invention is applied. The fuel filter device according to the fifth embodiment has a filter member 2G provided downstream of the fuel pump. FIG. 25 is a schematic cross-sectional view showing the fuel filter device according to the fifth embodiment. Each component part in FIG. 25 denoted by the same sign as in the second embodiment or the third embodiment is the same as the component part in the second embodiment or the third embodiment and exerts effects similar to the effects of the second embodiment or the third embodiment. The filter member 2G according to the fifth embodiment exerts effects similar to the effects of the second embodiment.

As shown in FIG. 25, the filter member 2G is an example of a high-pressure filter. The filter member 2G has middle layers 20E, 21E, 22E among the respective filter layers like the above-mentioned filter member 2E shown in FIG. 23. The filter member 2G is accommodated in a case 6, which has a fuel inlet 60 on one end side thereof and a fuel outlet 61 on the other end side thereof. A hot melt sheet section 200 as a sealing member is formed on an outer surface of the filter member 2G contacting an inner surface of the case 6. An adhesive 62 is filled between the hot melt sheet section 200 and the inner surface of the case 6. With such the sealing structure, the fuel flowing from the fuel inlet 60 to the fuel outlet hole 61 is caused to pass through the filter member 2G.

The fuel flowing into the case 6 through the fuel inlet 60 flows to pass through the most upstream first filter layer 10A, the middle layer 20E, the second filter layer 11A, the middle layer 21E, the third filter layer 12A, the middle layer 22E and the innermost fourth filter layer 13A in series. Thus, the fuel is filtered by the respective filter layers as explained in the description of the third embodiment.

### Sixth Embodiment

Next, a sixth embodiment of the present invention will be described. The sixth embodiment is another form of a fuel filter device, to which the present invention is applied. The fuel filter device according to the sixth embodiment has a filter member 2H provided downstream of the fuel pump like the fifth embodiment. FIG. 26 is a schematic cross-sectional view showing the fuel filter device according to the sixth embodiment. Each component part in FIG. 26 denoted by the same sign as in the first embodiment or the fifth embodiment is the same as the component part in the first embodiment or the fifth embodiment and exerts effects similar to the effects of the first embodiment or the fifth embodiment. The filter member 2H according to the sixth embodiment exerts effects similar to the effects of the above-mentioned first embodiment.

As shown in FIG. 26, the filter member 2H is an example of a high-pressure filter. The filter member 2H has middle layers 20E, 21E, 22E among the respective filter layers like the above-mentioned filter member 2E shown in FIG. 23. In the filter member 2H, like the fuel filter device according to the fifth embodiment, the fuel flowing into the case 6 through the fuel inlet 60 flows to pass through the most upstream first filter layer 10, the middle layer 20E, the second filter layer 11, the middle layer 21E, the third filter layer 12, the middle layer 22E and the innermost fourth filter layer 13 in series. Thus, the fuel is filtered by the respective filter layers as explained in the description of the first embodiment.

The filter member 2H according to the present embodiment has a construction, in which the middle layers 20E, 21E, 22E having larger void ratios than the filter layers are interposed among the filter layers adjacent to each other in the thickness direction. Since the void ratios of the middle layers are larger than the void ratios of the filter layers, the fuel having passed through the through holes 101,111,121 can be distributed widely to the downstream filter layers. The middle layers 20E, 21E, 22E have functions to maintain the intervals among the filter layers at predetermined intervals, thereby stabilizing the shape of the filter member 2H.

### Seventh Embodiment

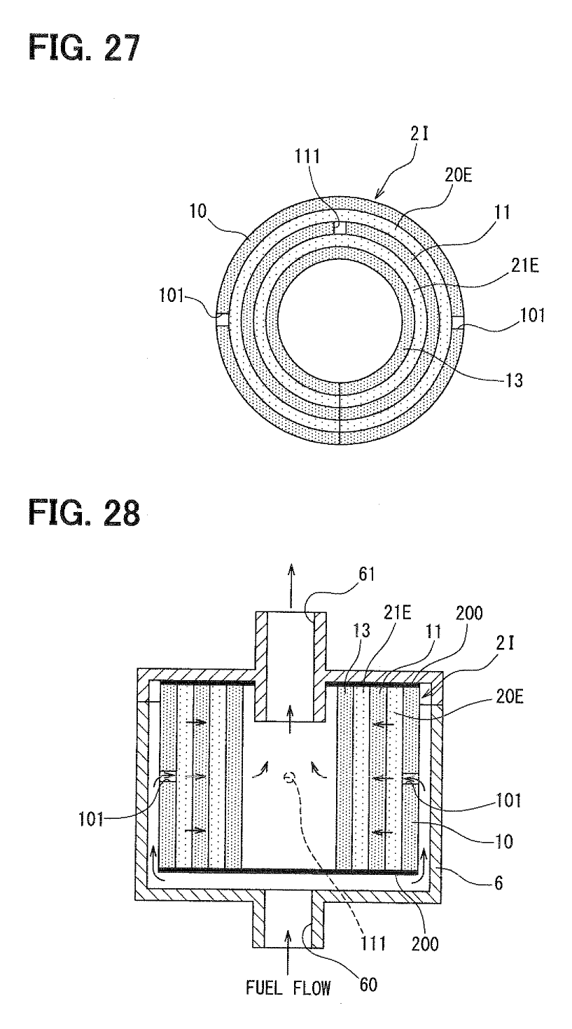

Next, a seventh embodiment of the present invention will be described. The seventh embodiment is another form of the fuel filter device, to which the present invention is applied. The fuel filter device according to the seventh embodiment has a filter member 2I provided downstream of the fuel pump. FIG. 27 is a schematic cross-sectional view showing the filter member 2I according to the seventh embodiment. FIG. 28 is a schematic cross-sectional view showing the fuel filter device according to the seventh embodiment. Each component part in FIGS. 27 and 28 denoted by the same sign as in the first embodiment or the sixth embodiment is the same as the component part in the first embodiment or the sixth embodiment and exerts effects similar to the effects of the first embodiment or the sixth embodiment. The filter member 2I according to the seventh embodiment exerts effects similar to the effects of the first embodiment and the sixth embodiment.

As shown in FIGS. 27 and 28, the filter member 2I is an example of a high-pressure filter. Like the above-mentioned filter member 2E or the filter member 2G, the filter member 2I has middle layers 20E, 21E, 22E among the filter layers. The filter member 2i is formed in the shape of a cylindrical body. The filter layers and the middle layers are formed in the shapes of multiple coaxial pipes.

The filter member 2I is accommodated in a case 6, which has a fuel inlet 60 on one end side thereof and a fuel outlet 61 on the other end side thereof. Hot melt sheet sections 200 as sealing members are formed on a bottom surface and a top surface of the cylindrical body. One of the both hot melt sheet sections 200 on the bottom surface and the top surface of the cylindrical body closely contacts an inner surface of the case 6 to seal a clearance between the hot melt sheet section 200 and the inner surface of the case 6. An adhesive may be filled between the hot melt sheet section 200 and the inner surface of the case 6. With such the sealing structure, the fuel flowing from the fuel inlet 60 to the fuel outlet hole 61 flows to pass through the fuel inlet 60, the cylindrical first filter layer 10 defining the outer cylindrical surface, the middle layer 20E, the second filter layer 11, the middle layer 21E and the fourth filter layer 13 defining the inner cylindrical surface in series. Thus, the fuel is filtered by the respective filter layers as explained in the description of the first embodiment.

### Other Embodiments

Above is the explanation of the embodiments of the present invention. The present invention is not limited to the embodiments. The present invention can be modified and implemented as follows, for example.

In the above-described embodiments, the cut sections, the holes, the slits and the like in the various shapes are used as the opening area variable sections that enlarge and open with the deformation of the filter layers due to the flow pressure of the fuel. However, the present invention is not limited to such the forms.

Although the nonwoven fabric layers are used as the filter layers in the above-described embodiments, the present invention is not limited thereto. Alternatively, for example, filter layers made of a material having a multiplicity of pores, which contribute to the void ratio, may be employed.

In the above-described embodiments, the filter member is formed in the rectangular sac-like shape. However, the shape of the filter member is not limited to the rectangular shape. Rather, the filter member may be formed in an arbitrary shape such as a circular shape or a polygonal shape. Alternatively, the filter member may be formed in a sheet-like shape instead of the sac-like shape.

In some of the above-described embodiments, the single opening area variable section or the single through hole is formed in each filter layer. However, the number of the opening area variable section(s) or the through hole(s) is not limited to the numbers described in the above embodiments. For example, multiple opening area variable sections or through holes may be provided in each filter layer.

In the above-described embodiments, the suction filter is applied to the fuel pump as an example. However, the fuel filter device according to the present invention is not limited to the fuel filter device applied to the fuel pump explained above. For example, the fuel filter device according to the present invention may be applied to a fuel supply device, in which a sub-tank is provided and a suction filter is arranged in a bottom portion of a fuel pump.

The construction according to the fourth embodiment (shown in FIG. 24) may be applied to the filter member 2 according to the first embodiment. With such the construction, the through hole is formed in the filter layer having the smallest void ratio among the filter layers except for the most downstream fifth filter layer 14F. With such the construction, the through hole is formed in the filter layer that is upstream of the most downstream fifth filter layer 14F and that starts clogging early among the multiple stacked filter layers. Therefore, even if the filter layer having the through hole clogs, the extraneous matters can be trapped by the downstream filter layer(s). Therefore, the lifetime of the entire filter member can be extended.

Combination of the constructions of the embodiments is not limited to the combinations as mentioned above. The constructions of the above-described embodiments may be combined with each other arbitrarily as long as the combination is feasible.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fuel filter device comprising:
a filter member including a plurality of filter layers stacked in a thickness direction, wherein
the fuel filter device removes extraneous matters contained in fuel when the fuel passes through the filter member in the thickness direction,
at least one of the filter layers has a fuel passing quantity variable section that is set with a pressure loss larger than a pressure loss in the other part of the filter layer than the fuel passing quantity variable section, and
the pressure loss in the fuel passing quantity variable section is set at a specific pressure loss such that a magnitude relationship between the pressure loss in the fuel passing quantity variable section and the pressure loss in the other part reverses in a process of accumulation of a passing quantity of the fuel passing through the filter member and progression of the removal of the extraneous matters.

2. The fuel filter device as in claim 1, wherein
the filter member has at least one gap between the filter layers adjacent to each other in the thickness direction, and
the fuel passing quantity variable section is a through hole having a predetermined opening area satisfying the specific pressure loss.

3. The fuel filter device as in claim 2, wherein
the specific pressure loss satisfied by the through hole resides in a range from 1.5 kPa to 4 kPa.

4. The fuel filter device as in claim 2, wherein
the through holes respectively provided in the filter layers adjacent to each other in the thickness direction are formed in positions deviated from each other in a direction perpendicular to the thickness direction such that the through holes do not overlap with each other in the thickness direction.

5. The fuel filter device as in claim 2, wherein
the through hole is formed in the filter layer having the smallest void ratio among the filter layers except for the filter layer arranged on the most downstream side with respect to a fuel flow direction.

6. The fuel filter device as in claim 1, wherein
the filter member has at least one middle layer, which has a larger void ratio than the filter layers, between the filter layers adjacent to each other in the thickness direction, and
the fuel passing quantity variable section is a through hole having a predetermined opening area satisfying the specific pressure loss.

7. The fuel filter device as in claim 6, wherein
the specific pressure loss satisfied by the through hole resides in a range from 1.5 kPa to 4 kPa.

8. The fuel filter device as in claim 6, wherein
the through holes respectively provided in the filter layers adjacent to each other in the thickness direction are formed in positions deviated from each other in a direction perpendicular to the thickness direction such that the through holes do not overlap with each other in the thickness direction.

9. The fuel filter device as in claim 6, wherein
the through hole is formed in the filter layer having the smallest void ratio among the filter layers except for the filter layer arranged on the most downstream side with respect to a fuel flow direction.

10. The fuel filter device as in claim 1, wherein
the filter member has at least one gap between the filter layers adjacent to each other in the thickness direction,
the fuel passing quantity variable section is an opening area variable section that enlarges and opens when the filter layer bends, and
the opening area variable section forms a through hole penetrating through the filter layer by enlarging and opening when the filter layer, in which the opening area variable section is formed, bends toward the filter layer on the downstream side with respect to a fuel flow direction due to flow pressure caused when the fuel flows in the process of the accumulation of the passing quantity of the fuel passing through the filter member and the progression of the removal of the extraneous matters.

11. The fuel filter device as in claim 10, wherein
the opening area variable sections respectively provided in the filter layers adjacent to each other in the thickness direction are formed in positions deviated from each other in a direction perpendicular to the thickness direction such that the opening area variable sections do not overlap with each other in the thickness direction.

12. The fuel filter device as in claim 10, wherein
the opening area variable section is formed in the filter layer having the smallest void ratio among the filter layers except for the filter layer arranged on the most downstream side with respect to the fuel flow direction.

13. The fuel filter device as in claim 10, wherein
the opening area variable section is a cut section or a slit penetrating through the filter layer.

14. The fuel filter device as in claim 1, wherein
the filter member has at least one middle layer, which has a larger void ratio than the filter layers, between the filter layers adjacent to each other in the thickness direction,
the fuel passing quantity variable section is an opening area variable section that enlarges and opens when the filter layer bends, and
the opening area variable section forms a through hole penetrating through the filter layer by enlarging and opening when the filter layer, in which the opening area variable section is formed, bends toward the filter layer on the downstream side with respect to a fuel flow direction due to flow pressure caused when the fuel flows in the process of the accumulation of the passing quantity of the fuel passing through the filter member and the progression of the removal of the extraneous matters.

15. The fuel filter device as in claim 14, wherein
the opening area variable sections respectively provided in the filter layers adjacent to each other in the thickness direction are formed in positions deviated from each other in a direction perpendicular to the thickness direction such that the opening area variable sections do not overlap with each other in the thickness direction.

16. The fuel filter device as in claim 14, wherein
the opening area variable section is formed in the filter layer having the smallest void ratio among the filter layers except for the filter layer arranged on the most downstream side with respect to the fuel flow direction.

17. The fuel filter device as in claim 14, wherein
the opening area variable section is a cut section or a slit penetrating through the filter layer.
